(19) United States
(12) Patent Application Publication
(10) Pub. No.: US 2015/0261918 A1
(43) Pub. Date: Sep. 17, 2015

(54) SYSTEM AND METHOD FOR MEDICAL SERVICES THROUGH MOBILE AND WIRELESS DEVICES

(71) Applicants: William C. THORNBURY, JR., Glasgow, KY (US); JOBATHCO ENTERPRISES, INC., Glasgow, KY (US)

(72) Inventor: William C. Thornbury, JR., Glasgow, KY (US)

(21) Appl. No.: 14/434,994

(22) PCT Filed: Oct. 11, 2013
(86) PCT No.: PCT/US13/64455

§ 371 Date: Apr. 10, 2015

Related U.S. Application Data
(60) Provisional application No. 61/712,308, filed on Oct. 11, 2012.

(51) Int. Cl. G06F 19/00

(52) U.S. Cl. CPC G06F 19/322; G06F 19/3418; G06F 19/328

(57) ABSTRACT

System and method providing medical services through hand held wireless devices, including smart phones and tablets, includes a central interface server communicating with physician's and patient's devices and is especially adapted for use in treating minor or chronic medical conditions not requiring an in-person medical visit. The system includes a medical interrogation engine for structuring a presenting complaint for hand held devices. The central interface server includes a treatment library of medical responses especially adapted for use in connection with hand held wireless devices from which the physician may select to establish and communicate a treatment plan unique to the patient. The patient and the physician may optionally include unstructured comments and the physician may optionally prescribe medications from the patient's pharmacy. A method is also included by which the physician may select, edit, and approve individual entries in the treatment library of medical responses.

### CROSS-REFERENCE TO RELATED APPLICATIONS

This application claims the benefit of priority based U.S. Provisional Patent Application Ser. No. 61/712,308 filed in the United States Patent and Trademark Office on Oct. 11, 2012, and entitled System and Method for Medical Services Through Mobile and Wireless Devices.

### FIELD OF THE INVENTION

This invention relates to the field of medical services, and more specifically to the use of electronic media in connection with the provision of medical services.

### BACKGROUND OF THE INVENTION

The United States healthcare system, arguably the envy of the world, has become increasingly complex, expensive to operate, and burdensome in providing care services to the populace. These inefficiencies, inseparably coupled with inefficiencies in the insurance and governmental systems that structure access to and delivery of healthcare services, have been the subject of contentious political, social, and industry debate for several years. Employers have typically provided healthcare insurance to employees through a combination of benefits and payroll deductions that can vary depending on the employer, the plans that the employer offers, and the insurance company selected. However, at least in part because the current healthcare system is complex, expensive, and burdensome, there remain many unemployed and uninsured or underinsured persons. Health insurance is available through the private market and through government programs. Nevertheless, there continues to be at least a perception of failure to increase the quality of service, improve customer satisfaction with the care experience, and to restrain spiraling costs that consistently exceed the country's overall inflation rate. The standards of today's healthcare economy are reflected by a 2005 summary statement of a joint Institute of Medicine/National Academy of Engineering panel assembled through the National Institutes of Health: The United States healthcare system is unsustainable in organization and delivery of services in its current architecture.

One of the principle drivers of U.S. healthcare costs is the inefficient distribution of care in a highly regulated environment. Even care for minor problems and routine follow-up visits to the doctor place a substantial financial burden and time commitment on insurers, employers, employees, retirees, and the uninsured. Market forces in this highly regulated environment have been unsuccessful in restraining costs. It has been conservatively estimated that at least $700 billion USD is wasted annually. A 2009 Price Waterhouse Cooper white paper placed the waste at $1.2 trillion. A 2008 review suggested that 70% of the entire healthcare system dollar was spent on services that could have been avoided.

One of the most expensive ways in which medical care is provided is through emergency medical facilities in hospitals. As many as 65 million emergency room visits annually could be unnecessary. The U.S. government has reported that, for 2009, the average emergency room visit costs $1,318. Waiting times are typically over four hours. Even in primary care there is a belief that 40 or more of patient encounters could be completed in the absence of a physician examination of the patient.

The Association of American Medical Colleges believes that by 2015 there will be a shortage of 63,000 physicians in the United States, and this shortage is projected to grow to over 130,000 physicians by 2025. Medical education requires a decade to fully mature physicians, meaning that shortages may be further exacerbated. Retiring physicians exacerbate shortages even more. One proposal for alleviating the looming problem of physician shortages is to broaden the pool of talent from which certain types of services may be obtained by using non-physician practitioners, sometimes called “ancillary care providers,” who typically have more limited training, where appropriate. Ancillary care providers include physician's assistants, nurses, physical therapists, and others. Even the best of the models promoting non-physician practitioners includes the need for providing training and supervision.

Despite the shortage of physicians, inefficiencies in service, the use of ancillary providers, and the cost of medical services, the demand for medical services is growing. There are more diseases recognized, more treatment options, and more opportunities to intervene to prevent or limit the progress of disease than ever before. Patients live longer than ever before. “Baby boomers,” our culture's largest population segment, now retire at a rate of 10,000 a day and will have continually increasing healthcare needs throughout the remainder of their lifetimes, typically at the rate of four physicians for every 10,000 retirees.

It is estimated that over 50 million U.S. residents are underinsured or uninsured and that half of uninsured adults did not see a doctor at all in 2010. For those that do see a doctor, approximately 55% receive less than the recommended health care. It is this population that is sometimes referred to as the “medically homeless.”

Even for the insured, the shortage of physicians can be expected to compromise access to healthcare. One-third of American citizens report difficulty obtaining timely appointments for routine care. Twenty percent of the population, which is about 65 million Americans, lives in rural areas covered by only 9% of available physicians. Another 20% are primarily Hispanic-speaking, for whom the language barrier can compromise care. Even under the best of circumstances, the offices of most primary care physicians are only open for forty hours per work week, which is less than 25% of the available 168 hours.

Legislative solutions to expand healthcare services to more members of society may increase the shortage of physicians, at least in the short term. Millions of persons are expected to enter the pool of patients under the Affordable Care Act of 2010. Considering the above problems in combination, there simply are not the financial and trained physician resources to sustain present systems of medical care. The system is expected to be crippled within the decade.

Various medical associations have promulgated the concept of the “Patient-Centered Medical Home,” or “Medical Home.” The Medical Home is a team-based healthcare delivery model, most commonly led by a physician, although sometimes also led by a physician's assistant, nurse practitioner, or other healthcare services practitioner. The purpose of a Medical Home is at least in part to provide comprehensive, continual, coordinated care in a patient-centered manner to improve the outcome for the patient, including improving or maintaining the quality of health, the safety of healthcare delivery, and reducing the cost. The Medical Home model promotes the use of new technologies and technological efficiencies for cost reduction, including the ability to include physicians with highly specialized practices in the routine care of patients remote from the physician. For example, modem computer technologies enable a physician with specialized training to provide input and supervision of medical care from a major urban center for a patient living in a remote rural area without either having to travel to the other's location. The highly trained specialist becomes part of the patient's Medical Home. However, the concept of the Medical Home has, generally speaking, not reached the primary care environment. The patient still must travel to the physician's office, and normally during limited business hours, for minor problems and routine care or follow-up. Care centers set up for more extended business hours sometimes are available, although visits to a doctor who is not the patient's regular, established physician normally are not considered as desirable. When emergency rooms are used for these purposes or for other medical conditions for which the emergency room concept was never intended, inefficiencies and costs skyrocket.

It would be desirable to develop a way to enhance providing cost-efficient medical services through established relationships among patients and medical services providers, including primary care physicians and ancillary care providers. A system for accomplishing this goal would desirably foster communication at a high, service-focused and patient-centered level among the patient and members of the patient's care team, which is the patient's Medical Home, including the patient's primary care physician and ancillary care providers. The system should be adaptable to work within existing models for increasing efficiencies in the provision of medical services and facilitate using the existing models in the most efficient manner possible. Generally, such a system would be expected to favorably impact at least one of, and preferably a combination of, convenience, cost, matching the service provided to the need, and eliminating unnecessary or wasteful services, all while contributing to patient and practitioner interaction, whether a primary care physician, family doctor, specialist, or ancillary care provider.

### SUMMARY OF THE INVENTION

The invention provides a system and method for physician and patient encounters that typically are not emergencies or those requiring a physical examination, but is uniquely suited for treating on a regular basis non-emergency medical conditions, including stable chronic disease states, minor medical conditions, and follow-up care, in which the medical visit is performed over mobile and wireless devices, including hand held devices and, for example, smart phones. The invention combines store-and-forward medical records, which may be provided synchronously or asynchronously, with real time, synchronous communications over the internet. The invention includes a medical library that can be customized upon delivery and in use by individual physicians and other providers of medical services to the standards of their practices. Over time, the services provider may continue to customize and refine the library based on clinical experience to establish an evolving library unique to the individual provider. In addition, the invention allows the services provider to add to the library entry comments, information, and directions based on the specific nature of the individual patient encounter. In this way, the system enables the medical services practitioner to establish a treatment plan for the patient that is unique to the patient. The system expands the service hours and opportunities for interaction between the patient and his or her medical team, including the primary care physician, and the efficiencies enable the medical services practitioner to complete a “care encounter” within from about 1 to 3 minutes in many circumstances.

In one embodiment, the invention provides a smart phone or tablet application in which a patient can access a central interface server via his or her handheld mobile or wireless device to pay for the patient's medical visit as required, to provide a structured presenting complaint to a physician or ancillary medical provider, the medical “practitioner,” and to optionally add unstructured free text, audio files, or video files for the medical provider to consider. The server notifies the practitioner via the practitioner's mobile or wireless device and the practitioner chooses whether the patient's presenting complaint and request for care are appropriate for on-line services by that practitioner. If so, the practitioner considers the patient's presenting complaint and the patient's health record, may optionally consult external references as needed, select from a library of previously refined, disease-specific, medical responses, optionally add comments in free text, prescribe laboratory services if necessary, issue prescriptions for medication or rehabilitative therapy as needed, and contact the patient with a complete informational and educational response. The entire matter is then stored in the electronic medical record for the practitioner's medical practice and on the central interface server. The central interface server typically will be provided by a subscription service that services multiple practices independently. The practitioner's contact with the patient can be entirely electronic, in which the patient accesses the server, the physician or other provider establishes a treatment plan, and the server notifies the patient of the treatment plan. The medical provider may also contact the patient for an audio or video conference in real time, if clinically dictated by the needs of the particular encounter.

In a more detailed embodiment, the invention provides an opportunity for the patient to review his or her prior personal health record (“PHR”) on his or her smart phone or other mobile or wireless device and to update the PHR as required, and enter optional comments, pictures, text and the like. The patient must then select a medical provider, which medical provider is made available through a previously established relationship with the patient, pre-approved by the provider's medical practice. Thereafter, the patient may complete consent forms, acknowledge any disclaimers, verify his or her account information, and make payment as required. The patient is prompted to complete his or her history of present illness (“HPI”), which is the means by which the patient informs the practitioner of his or her presenting complaint. Typically, the HPI is obtained via an interrogation engine driven by a logic engine based upon the patient's responses to questions or other prompts. The engine may be modified to provide the option of adding image and audio files. For example, the patient may have a smart phone by which a skin condition, including rashes, may be photographed and included for consideration by the practitioner. The patient may then log out.

Once the patient has completed the HPI, the HPI is sent to the central interface server where it is matched to the individual patient's PHR. The server then notifies the provider, who may be a primary care physician, specialist, or ancillary medical practitioner, via text message or email or other electronic means that a medical visit is pending on-line. The practitioner then logs into the interface server through his or her hand held device and the server downloads data to the practitioner's device. Several patients may do this in short succession. The practitioner can select from a list of patients the one he or she wishes to consider at the moment, and may then consider the HPI, PHR, optionally consider the medical practice office record, contact the medical practice laboratory, contact an external laboratory, the patient's pharmacy, consultant colleagues, or other external reference sources, including medical applications databases and the Orange Book of approved pharmaceuticals, among other resources. The practitioner may also contact the patient by audio or video conference. A non-physician practitioner may contact the physician practitioner.

Having fully considered the presenting complaint, health records, and available options, the practitioner can select a treatment plan from a library of previously refined medical responses for disease-specific indications, and may optionally add comments, prescribe medications, order diagnostic studies or laboratories, or take other action, including delaying making a decision, requesting an in-office examination or referral to a more specialized healthcare service. Once the practitioner has completed the encounter and submitted the disposition of the encounter to the central server, then the patient is notified via text message or email and the completed “e-visit” is stored on the central server as a “closed case” and in the practitioner's medical practice records. The practitioner may then select another patient from a case list or logout.

Thus, the invention provides a system and method in a new application for paired smart phones, paired between a patient and a medical services practitioner, to enable a medical “e-visit,” analogous to a house call, although the practitioner and the patient can be located anywhere internet service is available. The invention extends medical care beyond the traditional clinic into virtual space, improving patient access to care, reducing the time required for the medical visit, and improving provider productivity. The invention provides, in combination, store-forward and real time mobile telehealth services in which the medical visit is electronic. The invention provides the efficiency and turnaround time necessary to be useful on hand held mobile devices, and thereby to be sustainable as a technological model for the Medical Home in the treatment of non-emergency and stable chronic medical conditions. Efficiency of care management is maintained alongside individuality of care in part by coupling systems designed to direct clinical information in a concise and medically relevant manner, optionally including comments in the patient's own words, with a library of responses that can be customized for the individual practitioner's medical practice, optionally including unstructured comment to the patient. An entire care encounter, including considering the HPI, PHR, selecting a treatment plan, and submitting the plan, can be completed in from about 1 to 3 minutes.

### BRIEF DESCRIPTION OF THE DRAWINGS

The foregoing and other advantages and features of the invention and the manner in which the same are accomplished will be more readily apparent upon consideration of the following detailed description of the invention taken in conjunction with the accompanying drawings, which illustrate preferred and exemplary embodiments, and in which:

FIG. 1 illustrates in a global, modified spoke-and-hub diagram the principal relationships among the various functions of the invention, including provider's and patient's hand held devices and a central server, third party applications and software for financial transactions, medical interrogation, the patient's pharmacy, the healthcare provider's practice, external references, and file storage; and

FIGS. 2 thorough 7 are flow diagrams illustrating different aspects of the invention.

FIG. 2 illustrates in a flow diagram the principle functions associated with the patient's hand held device;

FIG. 3 illustrates in a flow diagram the principle functions associated with the provider's hand held device;

FIGS. 4A and 4B illustrate together in a flow diagram the principle functions and interactions associated with the patient's hand held device, the provider's hand held device, the central interface server, third party applications and software, the patient's pharmacy, and the provider's medical practice;

FIG. 4C illustrates more detailed features of a portion of FIG. 4A relating to structuring of the History of Present Illness and addition by the patient of optional files;

FIG. 5 illustrates a flow diagram for disposition of the medical visit by the provider;

FIG. 6 illustrates a flow diagram for a review function by which the provider can reconsider the medical encounter; and

FIG. 7 illustrates a flow diagram for development of a custom library by the physician to incorporate the physician's preferences in prepared responses.

FIGS. 8 through 27 are illustrations of smart phone screens adapted for use in the practice of the present invention on a healthcare provider's smart phone and are organized in sequence as a healthcare provider may see and use these screens in connection with patient treatment.

FIGS. 8 and 9 illustrate a healthcare provider's smart phone login screen for practice of the invention, the healthcare provider having opened the application on his or her smart phone and first encountering the login screen (FIG. 8) and entering a user name and password for security (FIG. 9);

FIG. 10 illustrates, after successful login, the first screen encountered by the healthcare provider, which is a list of cases to consider that are organized by patient name;

FIG. 11 illustrates the selection of a particular patient by the healthcare provider, which pulls up the initial screen of the patient's presenting complaint, the History of Present Illness, or “HPI;”

FIG. 12 illustrates consideration of the HPI, which has been structured to include an optional free text area for additional comments by the patient in the patient's own words;

FIG. 12A illustrates further consideration of the HPI which has been structured to include optional additional video and audio components;

FIG. 13 illustrates the healthcare provider having considered the HPI and continuing to begin consideration of the patient's Personal Health Record, or “PHR;”

FIG. 13A illustrates an enlarged reference photo of the patient for use by the healthcare provider in considering the patient;

FIG. 14 illustrates, after successful completion of consideration by the healthcare provider of the HPI and PHR, the first screen of a reference library of custom prepared responses from which the healthcare provider may select, the screen illustrating in this instance a list of topics organized alphabetically and beginning with the letter “S;”

FIG. 15 illustrates selection of a particular library item selected by the healthcare provider after having considered the HPI and PHR of FIGS. 12 through 13A;

FIG. 16 illustrates a screen from which the healthcare provider may complete the present patient encounter, called the “disposition” screen, and showing a free text area in which the healthcare provider may add unstructured comments to the patient and various options for selection by the healthcare provider;

FIG. 17 illustrates the healthcare provider having selected the “submit” function to complete and forward the patient encounter;

FIG. 18 illustrates the healthcare provider having successfully submitted a previous patient encounter and being returned by the application to the initial cases screen similar to that of FIG. 10, although showing the deletion from the current cases of the previously submitted encounter;

FIG. 19 illustrates the healthcare provider, rather than selecting the “submit” function on the disposition screen of FIG. 16 as is the case for FIG. 17, instead selecting the “pharmacy pending” function on FIG. 16 to mark the case as pending, store the information for further encounter at a later or more convenient time, and return to the initial cases screen similar to that of FIG. 10, although in this instance highlighting the pending case in the list of pending cases for later additional consideration and other potential disposition;

FIG. 20 illustrates the healthcare provider, rather than selecting the “submit” function on the disposition screen of FIG. 16 as is the case for FIG. 17, or the “pharmacy pending” function of FIG. 19, instead selecting the “review” function on FIG. 16 to place before the healthcare provider the first screen of the HPI for review;

FIG. 21 illustrates the healthcare provider having selected the ‘review” function in accordance with FIG. 20 and progressing to review the first page of the PHR;

FIG. 22 illustrates the healthcare provider having selected the ‘review” function in accordance with FIG. 20 and progressing to the first page of review of the treatment, which is the library selection made in accordance with FIG. 15 for the particular patient encounter selected;

FIG. 23 illustrates the healthcare provider, rather than selecting the “submit” function on the disposition screen of FIG. 16 as is the case for FIG. 17, instead selecting the “discard” function on FIG. 16 to dispose of, not the patient on the list of pending cases, but the treatment plan and library selection made by the healthcare provider, which returns the healthcare provider to the list of pending cases with the particular patient that was selected appearing as a previously unexamined case in the queue;

FIG. 24 illustrates selection for review of “closed cases,” which are cases of which the healthcare provider has previously disposed and submitted, and searching by the healthcare provider of closed cases beginning with the letter “J;”

FIG. 25 illustrates the first screen of the HPI for a previously submitted patient encounter;

FIG. 26 illustrates the first screen of the PHR for a previously submitted patient encounter;

FIG. 27 illustrates the first treatment screen, or library selection for the particular encounter selected in “closed cases.”

Corresponding reference characters indicate corresponding parts throughout the several views of the drawings. Related, but not identical steps or features normally are indicated with the use of primes. In some views of the drawings multiple steps or features are sometimes indicated as a single step or feature for convenience and may be separately illustrated as multiple steps or features individually numbered in prior or subsequent drawings. Generally speaking, multiple steps or features related in this way are numbered within the same group of 100's or 10's as the case may be.

### DETAILED DESCRIPTION

The invention can best be understood with reference to the specific embodiments that are illustrated in the drawings and the variations described hereinbelow. While the invention will be so described, it should be recognized that the invention is not intended to be limited to the embodiments illustrated and described. On the contrary, the invention includes all alternatives, modifications, and equivalents that may be included within the spirit and scope of the invention as defined by the appended claims.

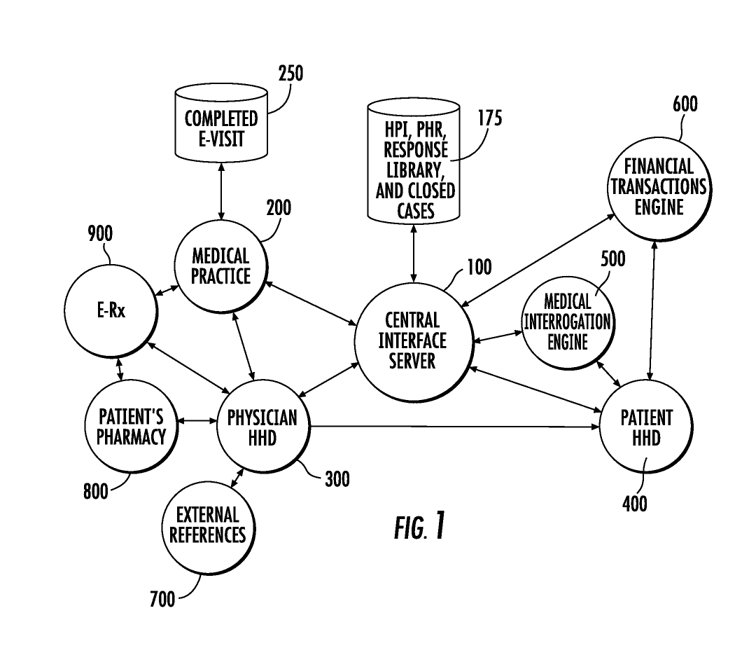

The spoke-and-hub diagram of FIG. 1 illustrates the communication system of the invention in a global manner to orient the reader to the principal relationships for providing medical services by way of mobile or wireless devices. The nine primary features of the system are numbered by the 100's, each of which is discussed in more detail below. The invention relies on a specific web application, commonly called an “app,” to be described in more detail below and which resides in a central interface server 100. The app can be supported by a variety of web browsers, including, but not necessarily limited to, browsers for hand held devices. Generally, it is intended that a single server could service multiple medical practices independently and that each practice will subscribe to the server owner for access to the app. Once a medical practice 200 has licensed the use of the app and made it available to the medical services practitioners associated with its practice, physician and non-physician ancillary providers (the medical “practitioners”), then the medical services practitioners can download the app onto their hand held devices, including smart phones and the like.

FIG. 1 illustrates a single physician's hand held device at 300, which could be a personal digital assistant or PDA, including a smart phone, internet tablet, mobile internet device, or other hand held wireless device for mobile computing, including an enterprise digital assistant. It should be recognized that while there are features of this invention that make it uniquely suitable for communications with hand held mobile devices, the invention could also be used for laptop-to-laptop, desktop-to-desktop, and hardwired-to-wireless communications. However, the reverse is not necessarily true, for the unique features that enable the convenience and “go anywhere” mobile features that consumers demand and that enable the app to operate successfully over wireless hand held devices often precludes apps designed for desktop or laptop applications from useful application on hand held devices.

The physician's hand held device (“HHD”) 300 will most likely be a smart phone, possibly a tablet, but could also be a laptop or desk top computer. The physician's HHD receives data and information from the central interface server 100 and also communicates with the central interface server to download the interaction with the patient and 3rd party apps the doctor may call upon. It should be recognized that use of the app to provide medical services is not restricted to medical doctors, but could include any authorized person. One way of reducing medical cost is to use trained, non-physician, ancillary medical services providers where appropriate and as permitted under existing regulations, which can be expected to change from time-to-time. Although the drawings are labeled with respect to physician providers, it should be recognized that the invention applies to any of several non-physician ancillary medical services providers as well, and of which the drawings are representative. Thus, by “physician” as this term is used in the drawings, is included any provider of medical services, including, but not limited to, nurse practitioners, midwives, chiropractors, podiatrists, psychologists, veterinarians, veterinarian assistants, and others involved in the delivery of medical services to the extent these persons are authorized to use the apps. Of course, in the case of veterinarians and veterinarian's assistants, the term “patient” should be understood to include the animal patient's owner as the operator and user of the device and the invention on behalf of the animal patient.

FIG. 1 also illustrates a single patient's hand held device at 400, which could be a smart phone, tablet, or other hand held wireless device or could also be a laptop or desk top computer, although not necessarily with equivalent results. The patient's HHD 400 receives data and information from the central interface server 100 and also communicates with the central interface server to access the medical interrogation engine 500, the system for paying the medical practice invoices 600, and to allow the patient to review and update the patient's personal health record, or PHR. Data gathered by the medical interrogation engine 500 and the financial payment system 600 is transmitted to the central interface server 100 and stored. The physician or other provider may readily contact the patient through the app for real time communications, including by video or audio conference, simply phoning the patient if desired, but the patient should not normally readily have this capability to contact the physician, as is indicated by the one way communication arrow from the physician's HHD to the patient's HHD. It is intended in the practice of the invention that the communications be practitioner initiated.

The records of the history of present illness, or HPI, created by the medical interrogation engine, the personal health record, or PHR, and the library of prepared responses from which the physician or provider may choose to develop and communicate a treatment plan to the patient are stored as retrievable files in file storage media 175 on the central interface server 100. Once a patient's presenting complaint is gathered, structured as an HPI, stored on the central interface server 100 and communicated to the physician via his or her smart phone or other hand held device 300, then the physician can login to the system on the central server 100 and consider the HPI and the PHR. Thereafter, the physician may optionally consult external references as needed, select from a library of previously refined, disease-specific, medical responses, optionally add comments in free text, prescribe laboratory services if necessary, issue prescriptions for medication or rehabilitative therapy as needed, and contact the patient with a complete informational and educational response. If needed, the physician can use his or her smart phone to go to third party apps to consider external resources 700, including, for example, the physician's desk reference or the Orange Book listings for drugs having active ingredients, or the like. As indicated by the communication arrows, the third party apps for external references 700 typically are apart from any connection to the central interface server 100, although records retrieved can be downloaded and stored as required. Similarly, the physician may contact the patient's pharmacy 800 via the telephone or electronically as in e-prescribing at 900, which will typically be the same e-prescribing service as that of the physician's medical practice 200. Once submitted, the record of the medical encounter is stored as a “closed case” in the file storage unit 250 of the physician's medical practice 200 for later retrieval as needed, and as a “completed “e-visit” on the medical practice electronic storage media 250. It should be noted that the medical record will typically comprise the HPI, PHR, optional patient files, and the treatment plan selected and any optional files added by the physician. Information on prescriptions, external resources, consultancies, laboratories, and the like typically may not be routinely recorded, but can be if the physician desires to do so.

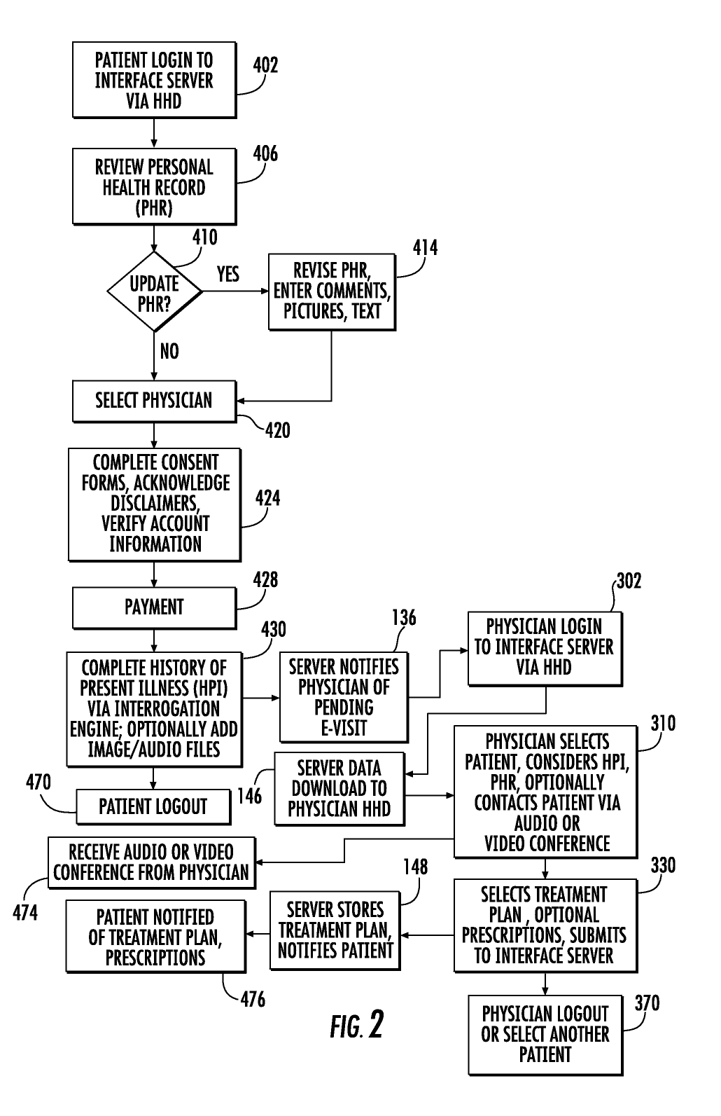

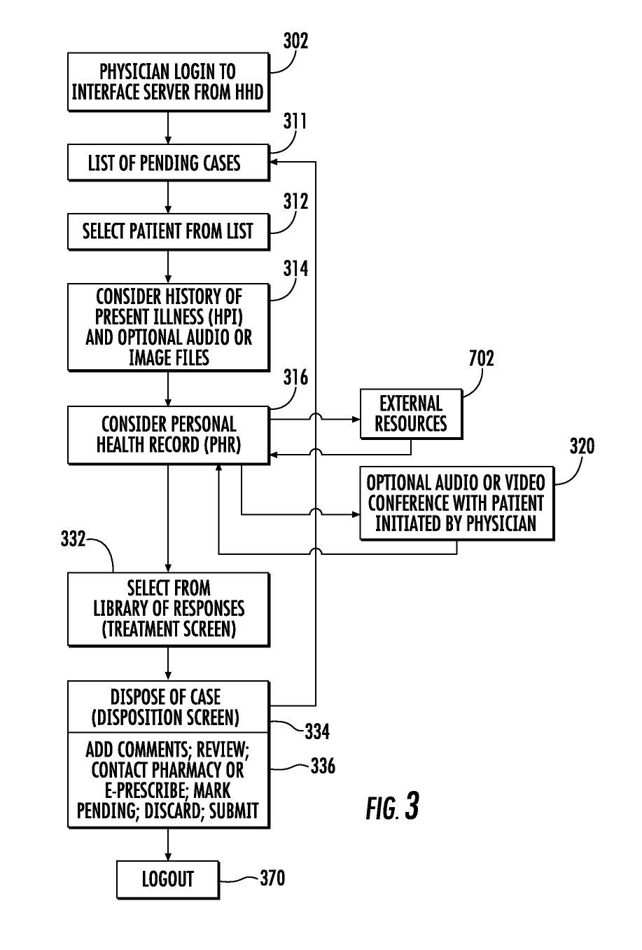

Turning now to FIG. 2, and with reference to FIG. 1, FIG. 2 illustrates a flow diagram for the patient's hand held device 400 (FIG. 1) along with selected interactions typical of a patient and physician encounter and including interactions with the central interface server 100 (FIG. 1) and physician's hand held device 300 (FIG. 1) as needed to illustrate operation of the patient's hand held device. Steps within a system element are numbered in the same group of 100's as the element.

The patient first must login to the interface server 100 with his or her HHD 400 as shown in FIG. 2, step 402. After logging in to the application, the patient considers his or her personal health record (“PHR”) in accordance with step 406. If the patient decides the PHR needs to be revised or updated, step 410, then the patient may do so as indicated at step 414. Thereafter, the server 100 (FIG. 1) prompts the patient to select a physician and, based on the patient's selection of physician at step 420, to complete the required disclaimers, fill out consent forms, and to verify the patient's account information from which payment will be made, step 424. Payment may then be collected in accordance with step 428.

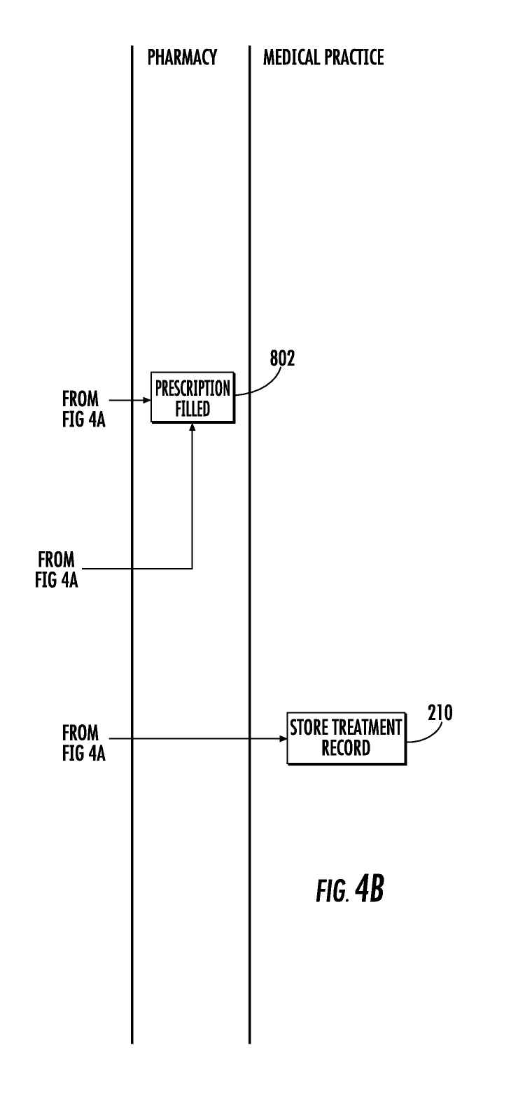

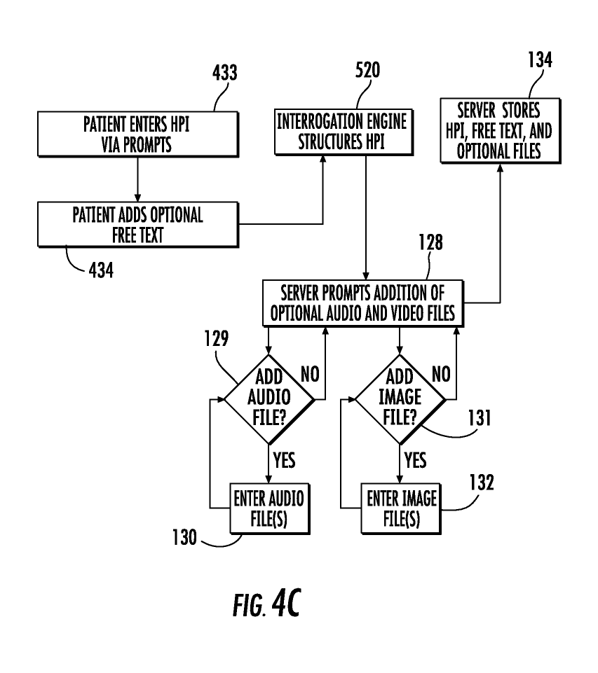

After payment has been made, the patient is prompted by the central interface server 100 (FIG. 1) to complete a history of present illness or “HPI.” The patient completes the HPI based on server prompts, step 430, FIG. 2. The central interface server communicates with a medical interrogation engine 500 (FIG. 1) and establishes communication between the patient's medical device 400 (FIG. 1) and the interrogation engine 500. The interrogation engine structures the HPI as the patient's presenting complaint and the patient is provided the option of adding unstructured comment and audio and video information, step 430, FIG. 2. These steps are described in further detail below in connection with FIGS. 4A, 4B, and 4C, which illustrate flow diagrams of systems interactions for patient's hand held device 400 with the physician's HHD 300, the server 100, third party apps, including a medical interrogation engine 500, a financial transactions engine 600, and an e-prescribing capability 900, along with external resources 700, the patient's pharmacy 800, and the medical practice server 200.

Returning now to FIG. 2, once the HPI and optional patient files are completed, step 430, then the patient may logout of the system, step 470, and the server, which has received the patient input from step 430, of the HPI and optional files, matches the HPI to the patient's files on the server and notifies the physician or other medical services provider of a pending medical visit via HHD, step 110 (FIG. 2). The physician receives a text message or email on his or her HHD 300 (FIG. 1) from the central interface server 100 (FIG. 1). The physician may then login to the interface server 100 from his or her HHD, step 302, FIG. 2.

In 6 seconds or less from successful login, the server downloads data for the patient to the physician's HHD in accordance with step 146. Once downloaded, the physician may select the patient from a list of several, consider the patient's HPI and PHR and, if desired, can optionally contact the patient, step 310, for a video or audio conference via the patient's HHD 400 (FIG. 1). Thereafter, the physician can select a treatment plan, has the option to write prescriptions and order drugs via electronic submission (900, FIG. 1) or by telephone to the patient's pharmacy (800, FIG. 1), and submit the treatment plan to the server, step 330, FIG. 2. Additional features are available to the physician, and these are described in more detail in the figures below. Thereafter, the physician may logout, step 370. The server stores the treatment plan and notifies the patient, step 148. The patient receives notification of the treatment plan via the patient's HHD, step 476.

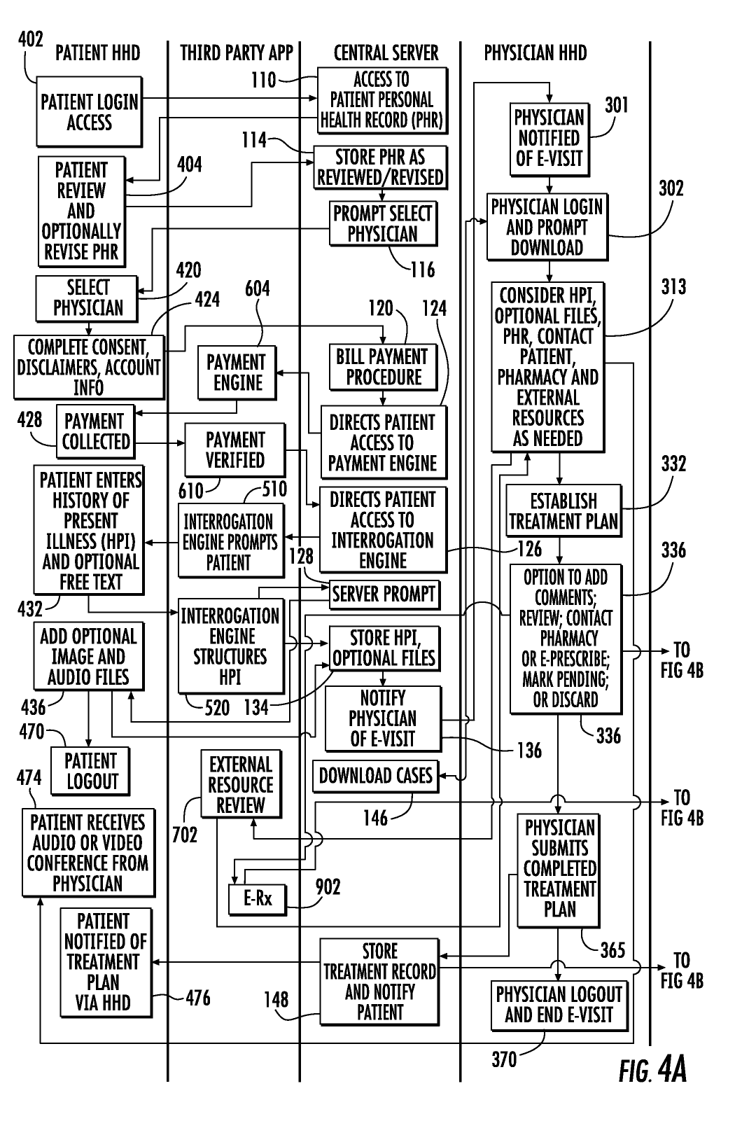

FIG. 3 illustrates the physician's HHD 300 (FIG. 1) in more detail from the point of the physician's login to the central interface server via the app, step 302. Once the physician has been notified by the server of the patient's presenting complaint, step 136, FIG. 2, logs in to the server from his or her HHD, step 302, FIGS. 2 and 3, and data is downloaded from the server, step 146, FIG. 2, then the physician may take the following actions, summarized as step 310 in FIG. 2 and set forth as individual steps 311 through 320 and 702 in FIG. 3, including reviewing a list of pending cases, step 311, generally organized alphabetically by the patient's name and the date and time their presenting complaint was recorded by the server, along with a short summary of their presenting complaint. The physician selects a patient from the list, step 312, and the app opens to the first page of the HPI so that the physician may consider the structured HPI and any unstructured comments and audio or video files the patient may have submitted, step 314. After considering the presenting complaint as set forth in the History of Present Illness, the app opens to the first page of the Personal Health Record, or “PHR,” so that the physician may consider the patient's complaint in the light of the patient's medical history, step 316. It is during this stage of the medical visit that the physician may access external resources, 700 (FIG. 1) via step 702, FIG. 3, and, if desired, contact the patient via telephone for an audio or video conference, step 320.

Once the physician has adequately completed the investigation by considering the HPI, patient comments and optional audio and video files, the PHR, optional external reference sources, and completed an optional video or audio conference with the patient, then the app opens on the physician's HHD to allow the physician to develop and dispose of a treatment plan, step 330, FIG. 2, detailed further as steps 332 through 336, FIG. 3. The physician is presented with a library of potential previously refined disease-specific medical responses to various patient complaints and from which the physician may select in developing a treatment plan, step 332, FIG. 3. The library is described in more detail below. Once one or more library items have been selected, then the app prompts the physician to dispose of the case in accordance with step 334 (FIG. 3). At this step, the physician may 1) add unstructured comments, 2) review any or all of the HPI screens, patient comments, audio or video files, the PHR screens, and the treatment plan selected, 3) contact the pharmacy to order a prescription, either by telephone or through an electronic prescribing app, 4) mark the case as pending for later disposition and submission, request an in-office examination, or make a referral, 4) discard the entire treatment plan and start over then or later, or 5) submit the treatment plan for storage and notification of the patient (collectively, step 336, FIG. 3). Once the physician has selected an option to dispose of the case, he or she may logout, step 370 (FIG. 3), or continue.

FIGS. 4A, 4B, and 4C illustrate interactions across flow diagrams of systems for 1) the patient's hand held device (FIG. 1 at 400 and FIG. 2, generally), 2), the physician's hand held device (FIG. 1 at 300 and FIG. 3, generally), and 3) the central server (FIG. 1 at 100 and FIG. 4A, generally) and of interactions across various third party apps 500, 600, 700, and 900, a pharmacy 800, and a medical practice 200, which are the primary entities globally illustrated in the spoke-and-hub diagram of FIG. 1. Beginning on the upper left of FIG. 4A and proceeding generally to the right and down the figure, and with reference to FIGS. 1 through 3 as needed, first, the patient logs into the server 100, from the patient's HHD 400 at step 402 to obtain access to the medical app for HHD communications. The central interface server 100 provides access to the patient on login to the patient's Personal Health Record, step 110, which the patient may review and optionally revise, step 404, FIG. 4A (detailed as steps 406, 410, and 414, FIG. 2). The server stores the PHR as it has been reviewed and optionally revised, step 114, and prompts the patient to select a physician, step 116, FIG. 4A, which the patient does to proceed, step 420, FIGS. 2 and 4A.

Upon proceeding, the server prompts the patient to complete the consent forms, acknowledge disclaimers, and to verify account information, step 424 (FIGS. 2 and 4A) and then prompts and provides access to a 3^{rd} party app, financial transactions engine 600, FIG. 1, via directed access to a third party application, steps 120 and 124. The server prompts access to a payment engine 604, which collects payment from the patient HHD at 428 (FIGS. 2 and 4A) and the payment engine verifies receipt of payment at 610. Upon receiving verification of payment from the 3rd party software, the server directs the patient's access to an interrogation engine, step 126, which is 3rd party software 510 that prompts the patient to enter a history of the present illness, step 432, which is a method of presenting a medical complaint. At the completion of the interrogation engine, the patient is prompted to add any unstructured, free, in his-or-her-own-words comments to be added to the HPI. The interrogation engine then structures the patient information into a traditional medical SOAP note format (“Subjective/Objective Assessment Protocol”), step 520, and the server prompts the patient at 128, to enter more data files including audio and image files at step 436. The HPI, unstructured comments, and any optional audio and video or image files are stored on the server, step 134, and a text or email message 136 is sent to the physician to notify the physician of the pending medical visit, step 301. Thereafter, the patient may log out, step 470.

The physician receives notification of the medical visit as indicated at the upper right of FIG. 4A, step 301. The physician must login to the server at step 302 to prompt a download of the patient's data from the server at 146. Thereafter, having selected the patient, step 312, FIG. 3, the physician may, in accordance with step 313, FIG. 4A, consider the HPI, optional files the patient may have added (step 314, FIG. 3), the PHR (step 316, FIG. 3), consider any external references 702, FIGS. 3 and 4A, contact the patient's pharmacy, if needed, via HHD, and contact the patient if needed (step 320, FIG. 3; step 474, FIG. 2) all in accordance with step 313 of FIG. 4A. The physician also can optionally consult with other physicians or practitioners.

Once having considered the HPI, the PHR and any additional files, the physician can establish a treatment plan, step 332. Generally, the treatment plan is established by selecting a library item from a group of such items that describe various disease conditions and treatments for the conditions. These library items are previously refined, disease-specific, medical responses, stored on the central interface server 100. Having selected the appropriate treatment plan, the physician then can add unstructured comment and dispose of the case at step 336. The physician has the option to review the HPI, PHR, and treatment plan, to write prescriptions, either by calling the patient's pharmacy directly, step 802, FIG. 4B, or electronically submitting the prescription, step 902, FIG. 4A, marking the case as pending for later disposition, or even discarding the treatment plan and starting over. Of course, the prescription may be for physical therapy, and the pharmacy may be a physical therapists location. These are not separately illustrated for convenience. If the physician's consideration of the records and development of the treatment plan is complete, the physician may submit the treatment plan and any comments to the server, step 365, and log out thereafter or select a new case, step 370. Once submitted, the server stores the treatment plan, step 140 as a now “closed case,” notifies the patient by text message or e-mail to the patient's HHD, step 476, and stores the completed e-visit on the medical practice's file storage media 250 (FIG. 1), step 210. FIG. 4B.

FIG. 4C illustrates in additional the sequence of steps across the server, interrogation engine, and patient's HHD for the preparation and delivery of the structured HPI and optional patient-submitted files of unstructured comments (step 432, FIG. 4A) and audio and video or image files (step 436, FIG. 4A; collectively, step 430, FIG. 2, as viewed from patient's HHD). This aspect of the invention is thought to be particularly beneficial in that it allows the patient to tell the physician about his or her complaint in the patient's own words and to include any pictures or sound the patient considers helpful in treatment, which enhances communication and increases patient involvement and responsibility for their care. After the server directs patient access to the interrogation engine, step 126, FIG. 4A, the patient is prompted to enter information for the HPI, step 433, FIG. 4C. Medical interrogation engines for patient interviewing software are readily available on the market. One example is offered as Instant Medical History, or IMH, from Primetime Medical Software located in Columbia, S.C. For use on hand held mobile devices, and in connection with capturing and storing documents including the presenting complaint, unstructured notes, and image and audio files, Evernote software is available as an application for mobile hand held devices, available as a free download from Evernote Corporation, Redwood City, Calif.

A unique feature is that at the end of the HPI, the patient may enter anything else the patient considers important as an optional, free text that will not be structured, step 434, FIG. 4C. The interrogation engine then structures the HPI, step 520. The server prompts the patient at step 128 to submit audio or image files or both, and up to about 5 each may be accommodated. If the patient decides to add an audio file at step 129 and enters the file at 130 or to add a video or image file 131 and enters the file at 132, then the server can store these files, along with the free text and the HPI at 134 prior to notifying the physician of the medical visit at step 136, FIG. 4A. Of course, if the patient adds none of these, or only selected ones of the unstructured comments, audio and image files, then the server stores the structured HPI and any selected files at 134 for forwarding to the physician via notification 136 and download 146 to the physician's HHD.

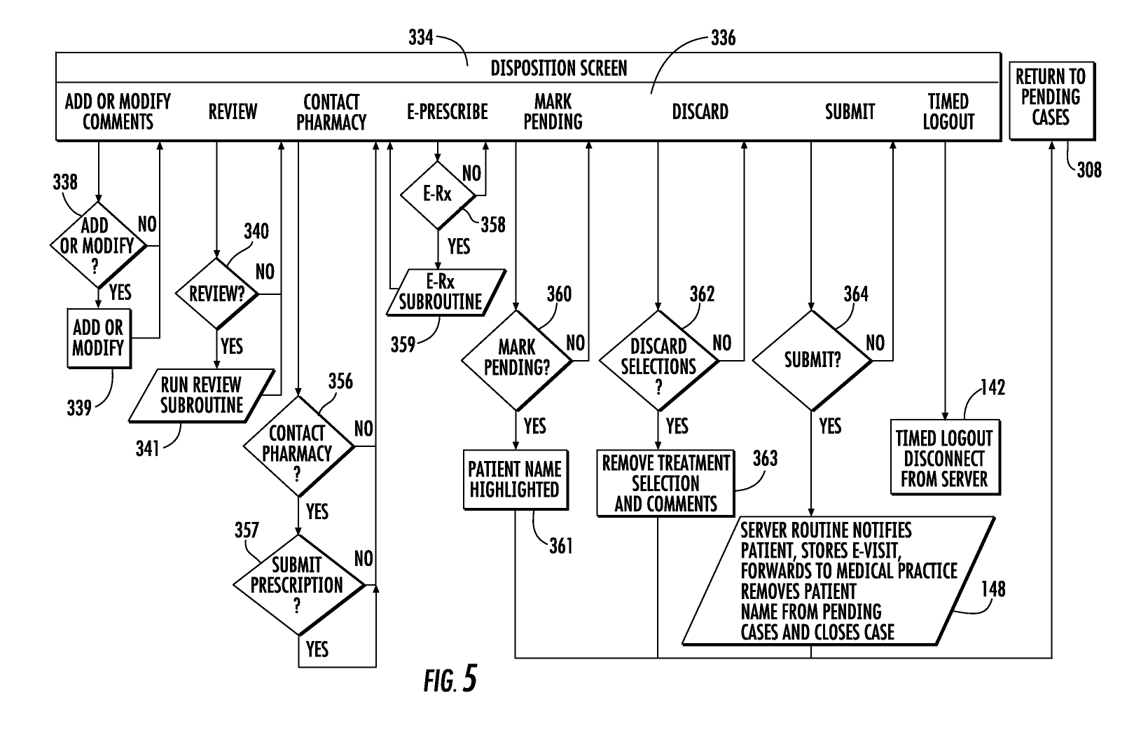

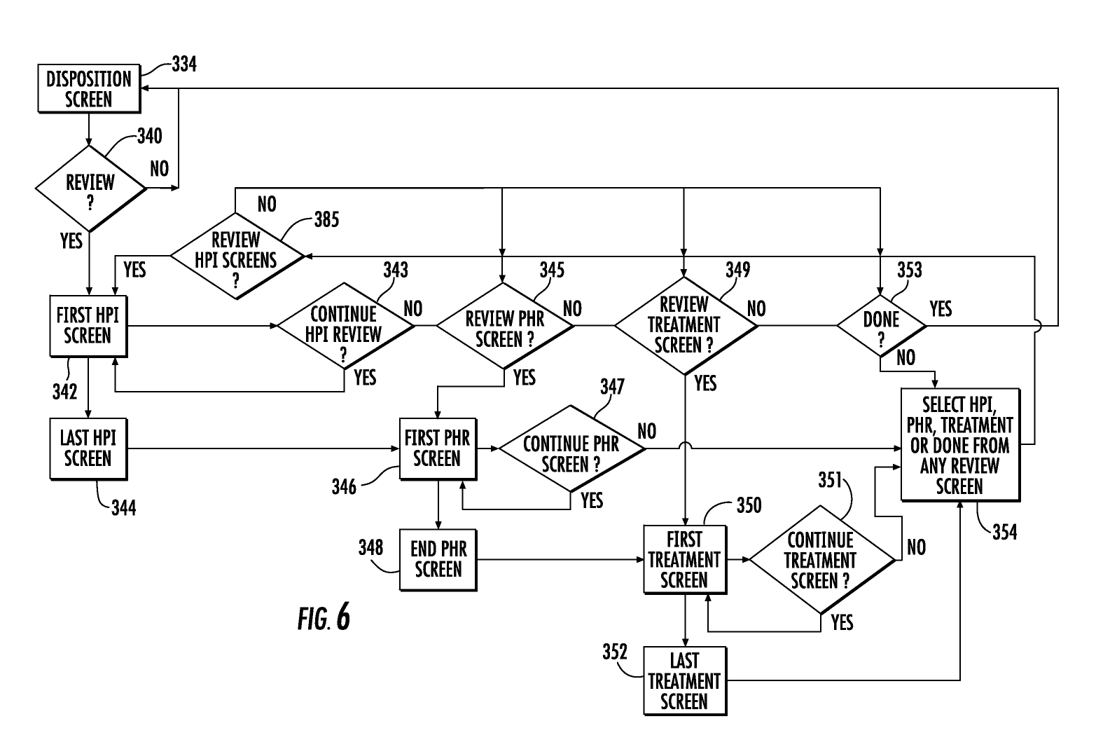

Turning now to FIG. 5, FIG. 5 illustrates the flow of steps available on the disposition screen 334 in more detail. The disposition screen, as shown in FIG. 3 comes up on the physician's HHD after the physician has made an initial assessment and treatment plan based on the HPI, PHR, and a selection from the treatment library. The disposition screen provides a graphical user interface that includes a control widget scroll bar for navigating screens within tabbed document interfaces, typically multiple document or functional interfaces for language-dependent hyperlinks 336 (see also FIG. 4A) that the physician may tap to dispose of the particular patient matter. For example, the physician may decide to add his or her own unstructured comments in a field provided on the disposition screen for this purpose, or to modify previously made comments, at step 338. If so, the physician enters the text or modifications at step 339 and is returned to the disposition screen for further action. If the physician decides to review the treatment plan, step 340, for any reason, then the physician can tap “review” to run a review subroutine that is described in connection with the following FIG. 6, step 341. For example, the physician may have been interrupted and need to review the treatment plan prior to returning to the disposition screen to submit the plan.

The physician may choose to contact the patient's pharmacy at step 356. After having established a treatment plan, the physician can call the pharmacy from his HHD or email or text the pharmacy and submit a prescription, step 357. Alternatively, the invention should be able to provide the capability of e-prescribing if the physician decides to use this capability, step 358. If so, then the e-Rx subroutine 359 runs. Typically, the e-Rx service is in the nature of a 3rd party app 900 (FIG. 1) and is the same one used by the physician's medical practice 200 and is in communication with the medical practice 200, the physician's HHD 300, and the patient's pharmacy 800.

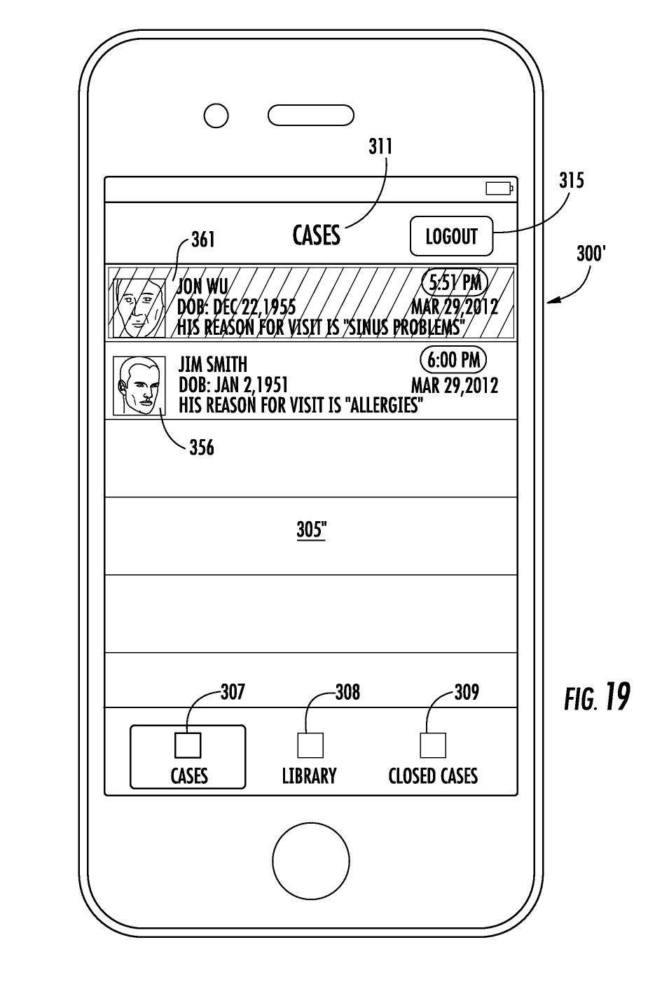

Returning again to FIG. 5 and disposition screen 336, the physician may also determine after selecting a treatment plan to delay final disposition, for whatever reason, and to thereby mark the case as pending, step 360. The app highlights the patient's name, step 361, on the list of pending cases from which the physician selects (see FIG. 19 for example, at 361), so that the physician will be alerted to pending, unresolved cases each time the list of cases is pulled up. If a case is marked pending, the app returns the physician to the list of pending cases, step 308.

The physician may also decide to discard a treatment plan, for whatever reason, step 362. Once this function is tapped, then the physician is presented the opportunity to delete the treatment plan selections and any additional comments the physician may have made, step 363. After a case treatment plan is discarded, the app returns the physician to the list of pending cases, step 308.

If the physician is on the disposition screen, has completed adding or modifying additional comments he or she may have optionally made, optionally reviewed the treatment plan, and contacted the patient's pharmacy or e-prescribed for the patient as needed, then the physician may decide to submit the treatment plan and any optional comments and prescriptions to the central interface server 100 (FIG. 1), in accordance with step 364. Once submitted, then in accordance with step 148, FIGS. 2, 4A, and 5, the server stores the treatment plan on its file storage media 175, FIG. 1, notifies the patient, step 148, FIGS. 2 and 4A, forwards the completed HHD medical visit to the medical practice 200 for storage on its file storage media 250, FIG. 1, step 148, FIGS. 2 and 4A, removes the patient from the list of pending cases, and closes the case. The app returns the physician to the list of pending cases 308 and the physician can select another patient if desired.

It should be noted that at any time the physician or other medical care provider is called away for any reason and does not attend to an active case file on his or her HHD, the app includes a timed logout feature 142 that will disconnect the HHD from the server, for security reasons.

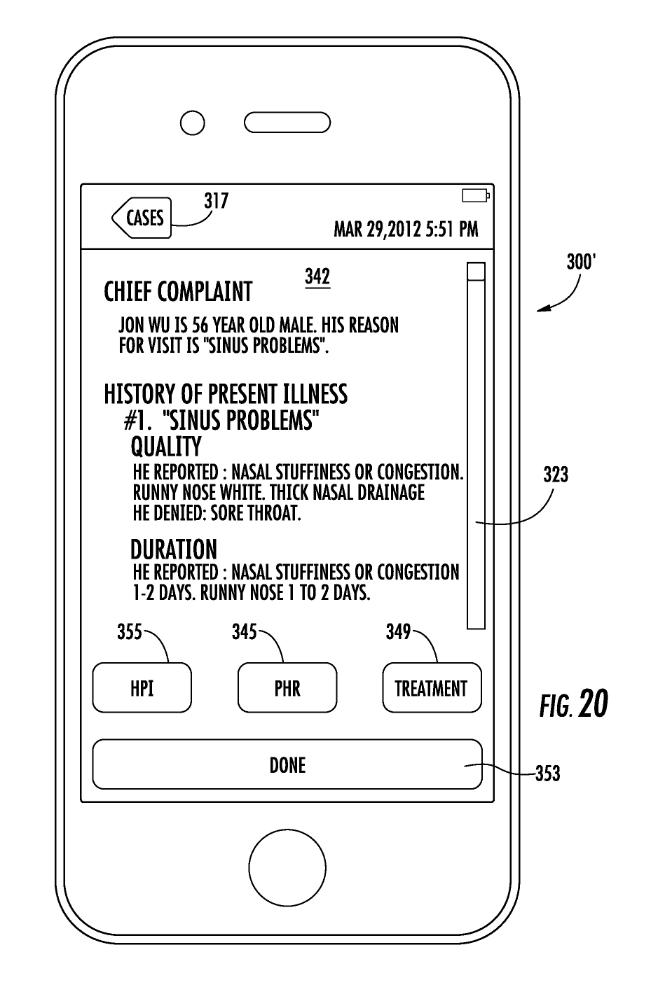

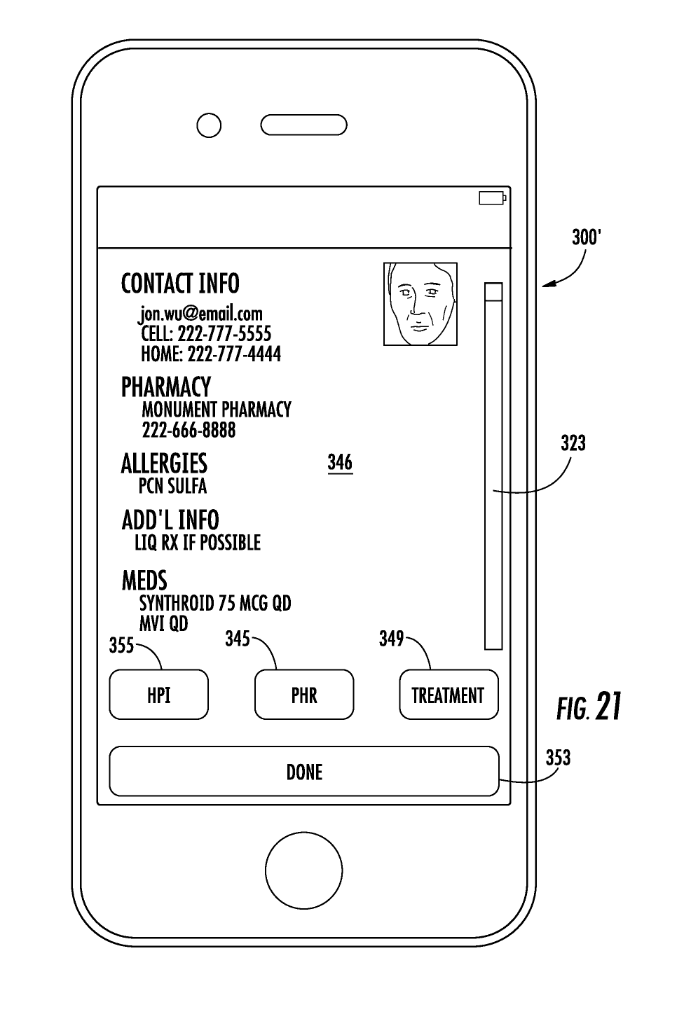

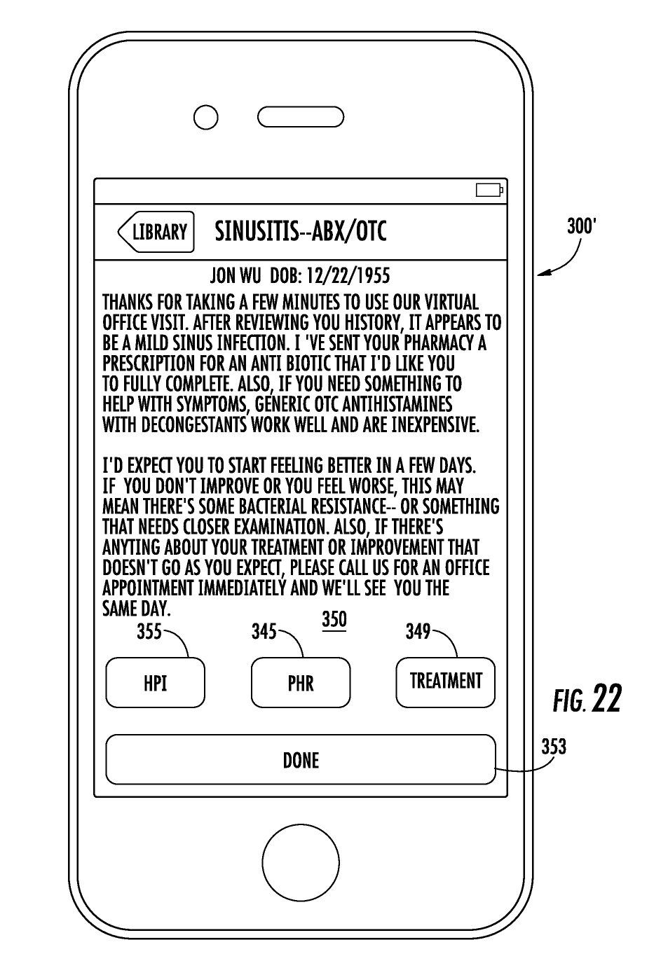

Turning now to FIG. 6 and a discussion of this figure in connection with the option to review the treatment plan for a case in making a disposition decision, FIG. 6 illustrates the disposition screen 334 with the isolated feature of review 340. Once the decision has been made by the physician to review the case, step 340, and the physician taps button 341 to run the review subroutine, then the app directs the physician to the first page of the HPI screen for review of the initial portion of the patient's presenting complaint in the History of Present illness, step 342. In the review mode, each screen includes text hyperlinks in multiple document interfaces for manipulating the review so that the physician can choose to end the review from any screen, proceed to the Personal Health Record, or “PHR,” or proceed to the treatment plan selected, or return to the disposition screen when the review is completed, at his or her discretion. See also FIGS. 20 through 22, discussed below. Thus it should be understood that while FIG. 6 illustrates a sequence of reviews through the HPI, PHR, and treatment screens, the system is flexible in use, and as shown in FIG. 6, the physician can make decisions in use to review only what the physician selects.

If the physician chooses to do so, he or she may review all the screens in the

HPI up to the last HPI screen 344, if desired, upon tapping the “review” button on the disposition screen, as indicated by the arrows. Upon review of the last HPI screen, the app automatically proceeds for review to the first PHR screen, step 346. If the physician continues straight through, he or she will review all of the PHR screens up to the end of the PHR screens 348. Upon review of the last PHR screen, the app automatically proceeds for review to the first treatment screen, step 350, and so forth through the last treatment screen 352. At this point, the physician must decide, step 354, whether to go back and review again any of the HPI, PHR, or treatment screens, steps 355, 345, and 349, respectively. If not, and the physician's review is complete, he or she may merely tap the button “Done” (FIG. 20), step 354, button 353, FIG. 6, to return to the disposition screen.

Alternatively, once tapping the review button and landing on the first HPI screen, the physician may make a decision not to continue review of the HPI screens and can tap button 345 for the PHR screens (FIG. 20) or button 349 for the treatment screens (FIG. 20) or button 353 for “Done” to return to the disposition screen 334. This decision tree is illustrated schematically in the flow chart of FIG. 6, which shows the physician making the decisions to continue review of the HPI, to initiate review of PHR, to initiate review of treatment, or to return to the disposition screen, steps 343, 345, 349, and 353, respectively. In making the decision to initiate review of any functional aspect of the app, HPI, PHR, or treatment, the app opens to the first screen for that function: first screen 346 for the PHR, first screen 350 for any treatment. As described, the physician can continue reviewing any of these screens to the end of the particular function or not, and if not, again may take the opportunity, step 354, to review another function or return to the disposition screen, including after the initial entry into the review mode, making a decision at 355 whether to review the HPI screens again.

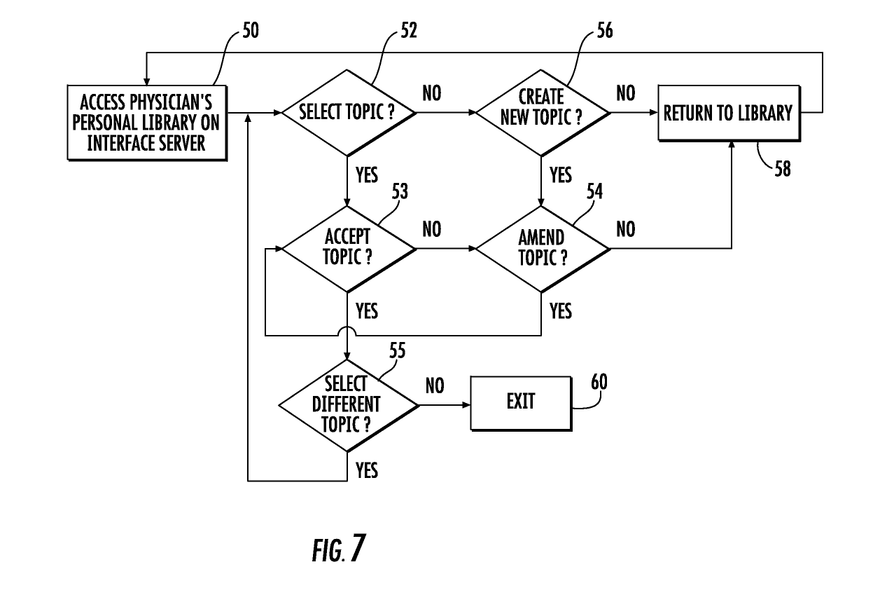

Turning now to a discussion of the library from which the physician may choose various treatment plans, and with reference to FIG. 7, FIG. 7 illustrates a physician's creation of a custom library unique to his or her practice, a library of previously refined, disease-specific, medical responses. Initially, step 50, the physician must access the physician's personal library on the interface server, 100, FIG. 1, from the physician's HHD 300, FIG. 1. It should be recognized that many of the functions can be performed by the physicians on other systems, including laptops and desktops, although the system has been designed in a manner specifically to work in connection with handheld devices, including smart phones and tablets. Although a physician may choose in some instances to use a desktop, as in when selecting, revising, and approving library responses, systems normally designed for use on a desktop cannot normally be used on a HHD in a ready manner, especially for providing medical services. However, having been designed to accommodate a HHD, the app should still be effective on a laptop and may be convenient in connection with creating and storing the library.

The physician's personal library is organized alphabetically by topic with abbreviations and the like typically used in the medical field and generally readily understood by physicians and medically trained personnel. Accompanying each topic is a description of the condition or disease. Initially, a library may be provided for a particular medical practice from the central interface server, with appropriate disclaimers and consents, from which the practitioner may create custom library entries. It should be recognized that a variety of libraries is envisioned, depending on the needs of the particular practice.

Once logged in and having access to his or her personal library on the interface server, a physician can assess a topic and either select it or not, step 52. If the physician does not select an existing topic, he or she may then have the option of deciding whether to create a new topic, step 56. If so, and the physician creates the topic in accordance with step 56, the physician is then provided the option of amending the topic, step 54, so that the topic matches personal preferences and experiences. Once the topic is amended, or in the event a physician has selected an already created and existing topic, the physician can accept the topic or not, step 53. If not, the physician may continue to amend the topic until accepted, or simply return to the library, step 58. Once a topic is selected or created, amended and accepted, steps 52, 56, 54, and 53, then the physician may select a different topic or exit the system, steps 55 and 60, respectively.

It should be recognized that the same flow diagram basically can be applied when making the original library, when a medical practice group or specialty creates and adopts a standard library, and if a physician simply wants to add an entry to a licensed library. The owner of the central server will, of course, require appropriate disclaimers and the like for use of the libraries by individual doctors and may from time to time offer updated single library items for acceptance and purchase and potential customization at the discretion of the practitioner. By customizing his or her individual responses, and optionally adding unstructured comment as warranted in the practitioner's discretion, the invention enables each practitioner to provide unique treatment to individual patients.

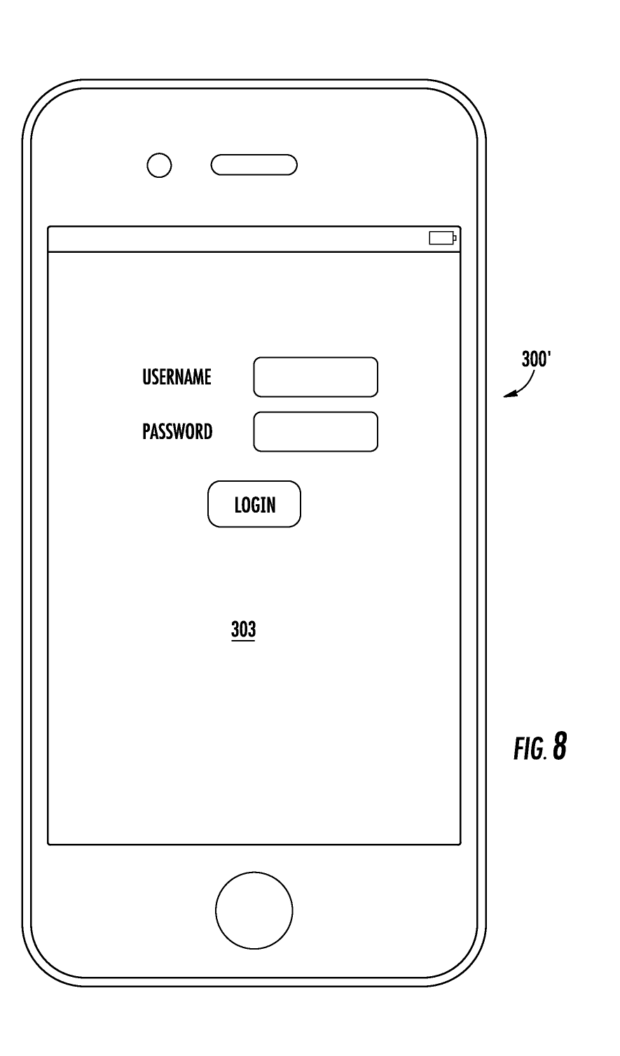

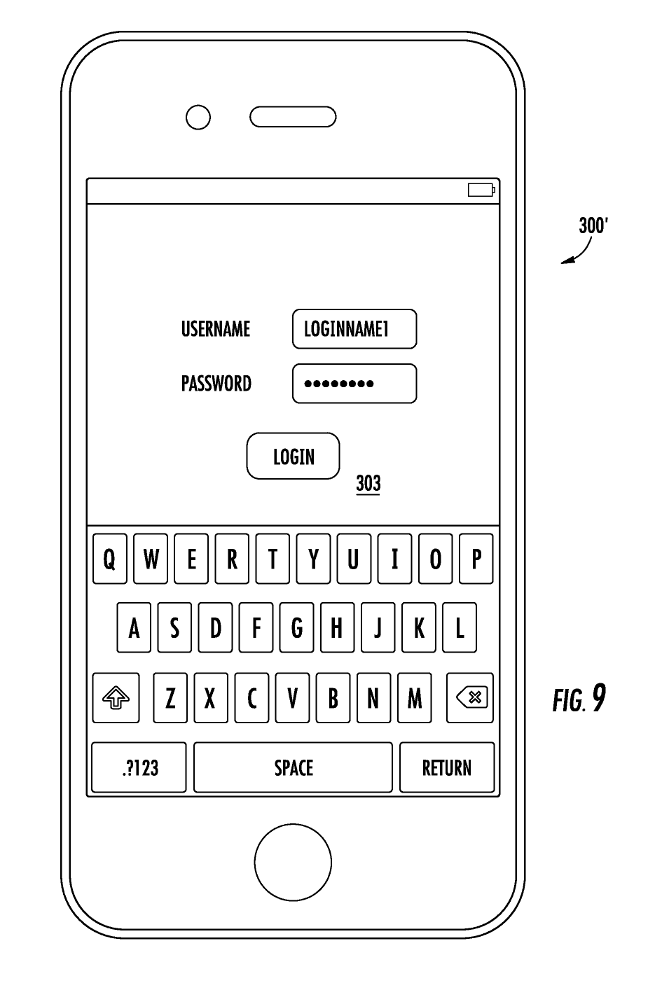

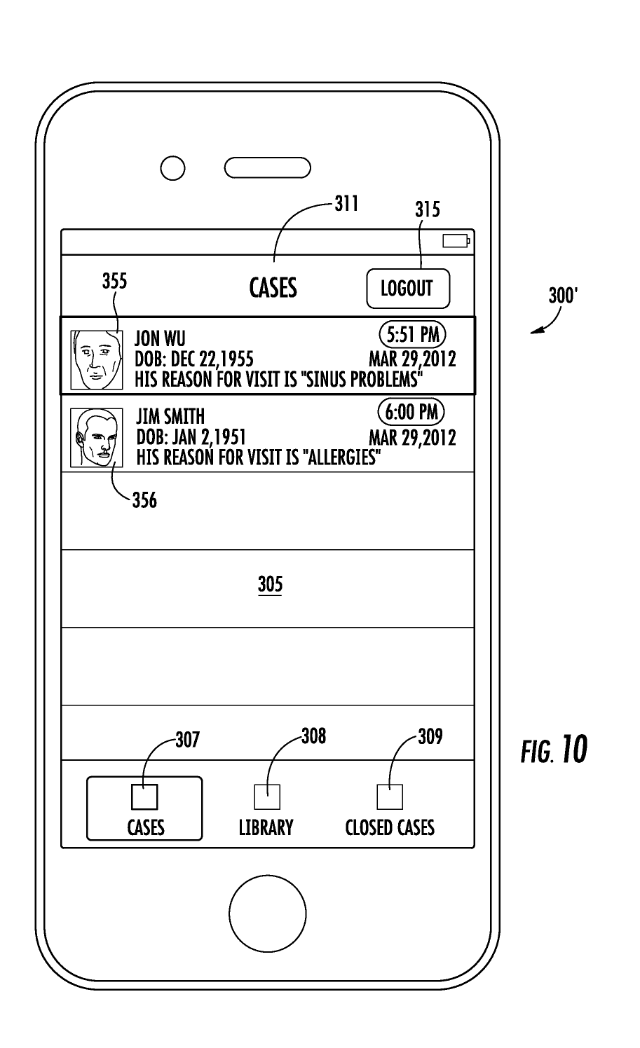

Turning now to a discussion of the invention in the context of use in a smart phone application, FIGS. 8 through 27 illustrate screen shots corresponding to the physician's hand held device 300 of the spoke-and-hub diagram of FIG. 1 and as described in connection with the flow charts of FIGS. 2 through 7. FIGS. 8 and 9 illustrate generally at 300 a physician's smart phone on which the physician has tapped an icon for the medical services of the invention to open the app to the login screen 303 where the physician must enter a username and password. FIG. 10 illustrates at 305 the first screen of the app encountered on successful login and download of data from the central interface server 100, FIG. 1. Cases screen 305 shows a list of two patients, Jon Wu and Jim Smith, identified by pictures 355 and 356, respectively, and having complaints for presentation to the physician and resolution of their complaints in a treatment plan. It should be recognized that the physician could have one or potentially more screens of patients presenting complaints by HHD. It should also be recognized that all names and case information used herein in connection with the drawings and the app are entirely fictitious.

The screen 305 is indicated to be the cases screen by the label 311 at the top section of the screen. To the right of the screen, the physician is provided with a logout button 315 for exiting the system. Each patient is listed by picture, name, date of birth, and a brief structured description of the patient's presenting complaint obtained from the History of Present Illness, or “HPI,” to the immediate right of the patient's picture. The day and time of the receipt of the presenting complaint are included on the right of the screen. As can be seen near the bottom of FIG. 10, navigation indicators 307, 308, and 309 are highlighted as at 307 to indicate whether the physician is in, respectively, the cases section of the app, the library section, or in a section devoted to cases previously disposed of by the physician and stored in file storage media 175 on the server and 250 in the medical practice.

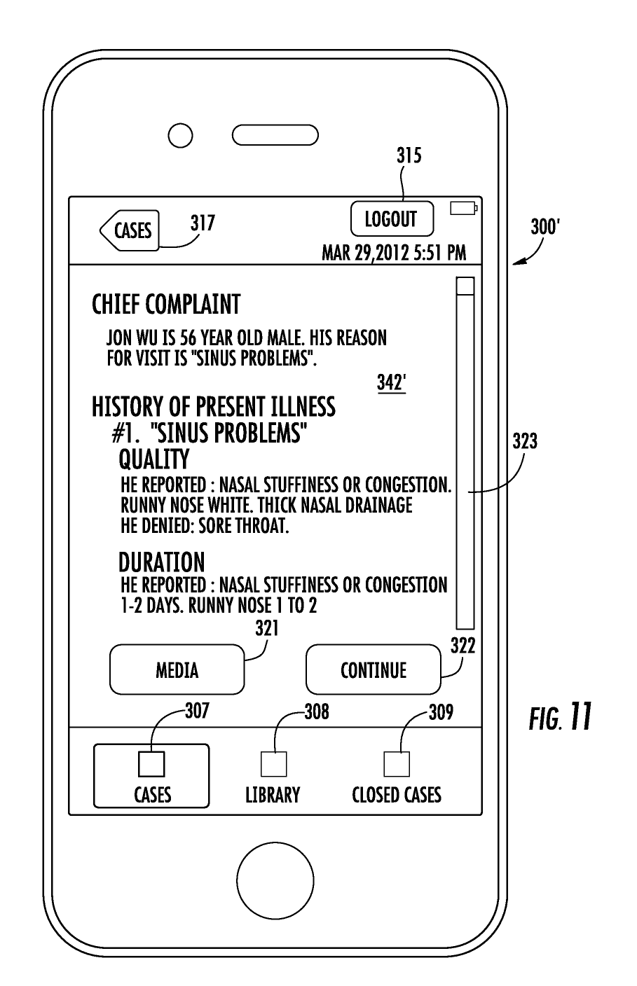

After selecting a case by tapping on the bar in which appears the name of the patient selected, in this case Jon Wu, the app loads the first HIP screen 342′ onto the physician's phone 300′ as illustrated in FIG. 11. The HPI typically may include several screens of information for the physician, the first of which are structured and organized. Screen 342′ is structured to provide the presenting or “chief” complaint as the reason for the patient's visit and includes name, age, and sex in addition. Remaining portions of the structure HPI are presented next. As indicated by the button 317 at the top of the screen, the physician may, if desired, take no present action in further review of Jon Wu's case and may return to the initial “cases” screen 305 to choose another patient from the list provided on screen 305. Alternatively, the physician may logout by tapping the logout button 315 on the upper right. It should be noted that the date and time of the patient's presenting complaint are recorded in the upper right beneath the logout button. The app is still in the “cases” location of the program, as is indicated by the highlighted navigation indicator 307 at the lower left. Additional text buttons 321, 322 are included, labeled as “media” and “continue,” respectively, so that from this screen, the physician may tap “media” at 321 to view audio or image files the patient has provided, or can tap “continue” at 322 to go to the next screen. Alternatively, a scroll bar, control widget 323, is provided by which the physician can scroll through screen 342′ to the next screen. It should be recognized that the media button is highlighted when the patient has submitted image or audio files to indicate to the physician that additional information remains to be considered. In the absence of such highlights, the physician knows that additional files were not included.

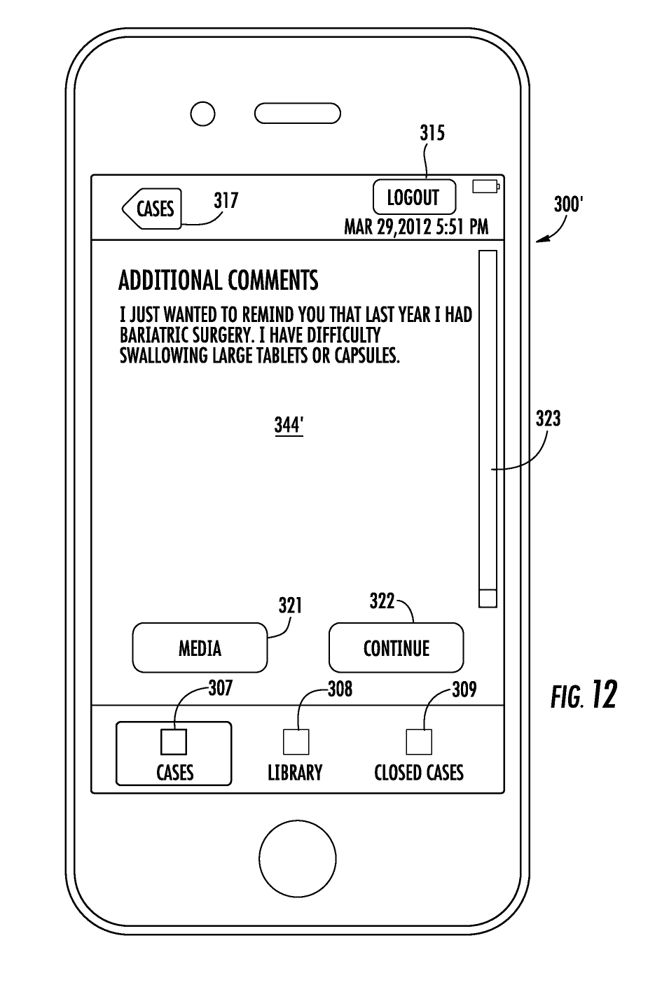

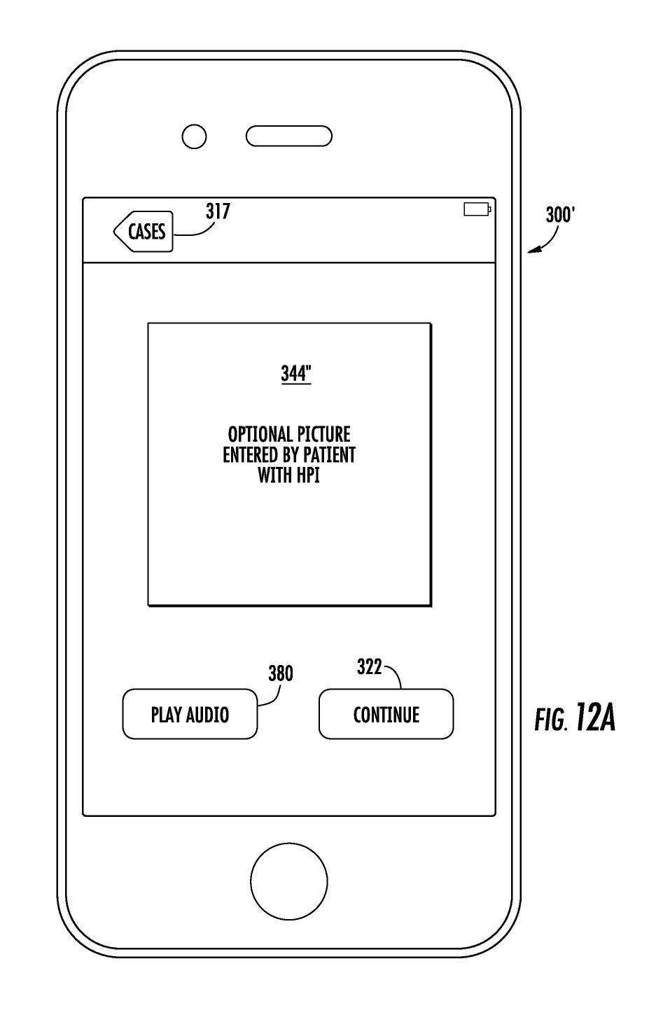

FIG. 12 illustrates screen 344′ in the HPI, which contains the patient's unstructured comments, labeled as “Additional Comments.” Typically, screen 344′ would be provided at the end of the structured HPI screens as the last HPI screen, unless the patient has added optional additional files for audio or video. Other features of the screen are similar to those of FIG. 11.

Upon tapping the media button 321, the physician opens screen 344″, illustrated in FIG. 12A, which brings up the image files entered by the patient in the HPI pursuant to the actions illustrated in connection with FIG. 4C. The patient may include images or video of, for example, an injury. Screen 344″ presents a button 380 labeled “play audio” if the patient has entered a sound file, including a voice message. It is immaterial whether the audio or image files appear first. Tapping “cases” 317 returns the physician to the last page of the structured HPI, screen 344′. Tapping “play audio” 380 opens the audio file. Tapping “continue” 322 on this screen opens the Personal Health Record, or “PHR” to the first PHR screen 346′.

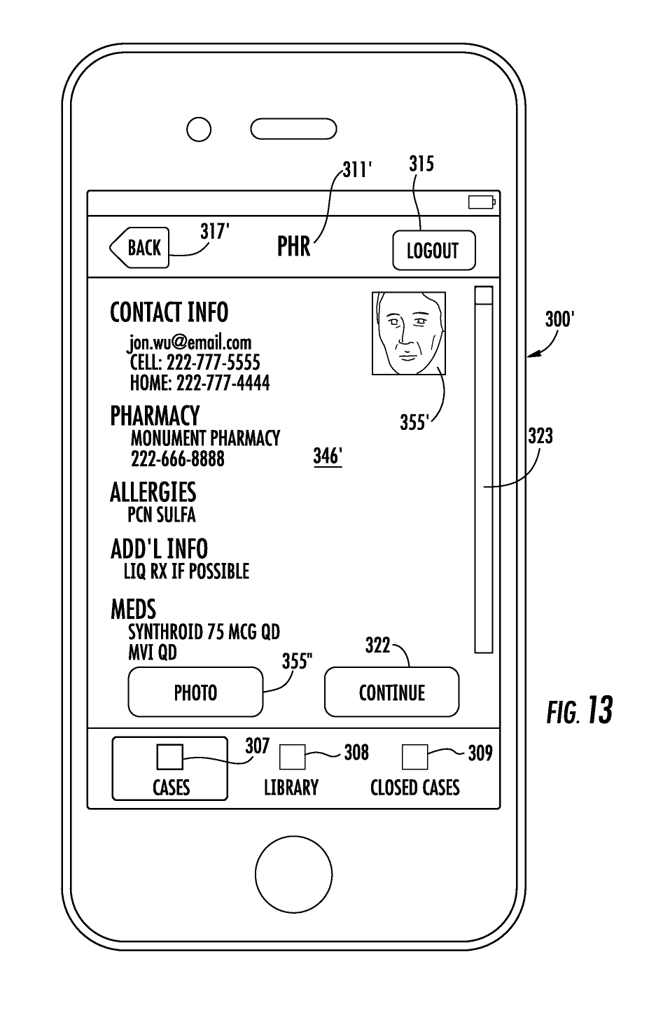

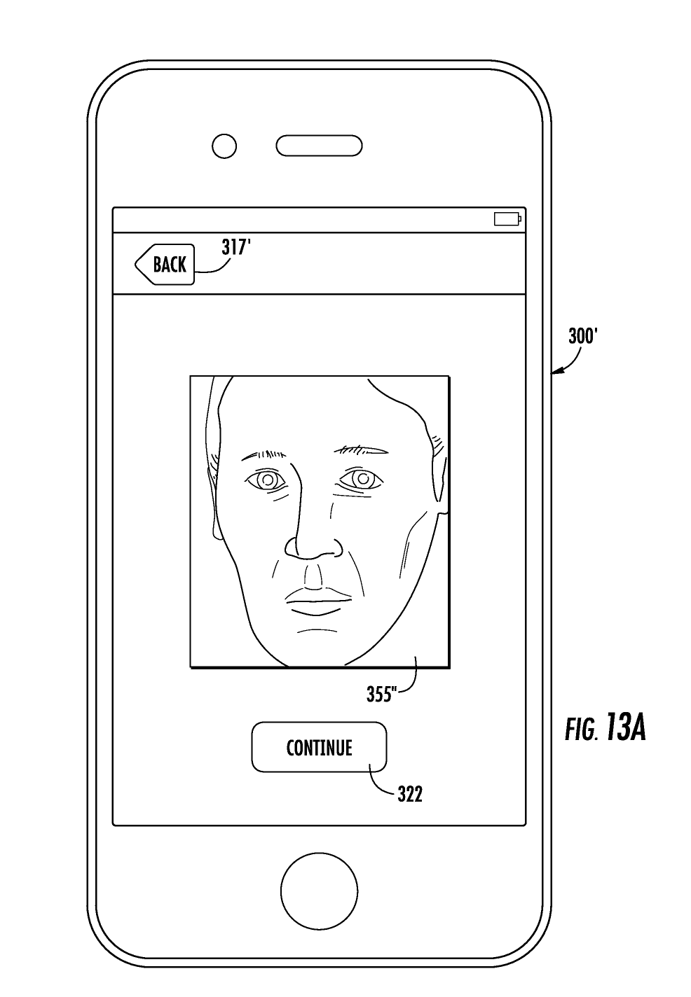

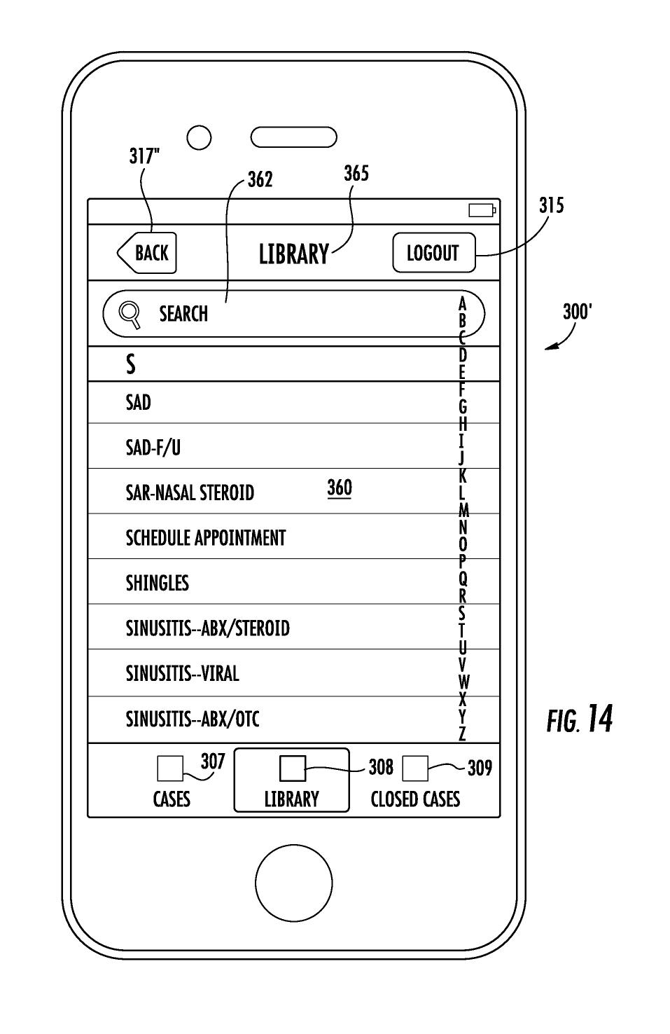

The first screen of the PHR, screen 346′, is labeled PHR at 311′ as illustrated in FIG. 13. Many of the operational features are similar to those of the HPI screens of FIGS. 11 through 12. However, tapping the “back” text button 317′ on the upper left will direct the physician back to the cases screen 305, FIG. 10. The patient originally selected from the “cases” screen 305, who is Jon Wu, is pictured on FIG. 13 in the photo image 355′ on the upper right of the screen 346′ beneath the “logout” button 315. The “photo” button 355″ on the lower left is for the purpose of allowing the physician to see a larger photo of the patient than the thumbnail at 355′. If the physician taps the photo button, then the following screen is that of FIG. 13A showing the enlarged image 355″ of Jon Wu. Tapping the continue button 322 moves the physician out of the cases aspect of the app and brings up the library screens, FIG. 14.

Before considering the library screens, and considering the PHR screens, the PHR is a structured presentation of information about the patient that is stored on the server 100, FIG. 1, and is the first set of screens to come up when the patient logs in, as discussed in connection with FIG. 2. The patient is required to review the PHR and provided the opportunity to update the PHR and to add comments, pictures, and text prior to entering the presenting complaint and prior to selecting the physician, completing forms, and payment, FIG. 2, steps 406, 410, and 414. The PHR may contain several screens of information, the first of which as illustrated in FIG. 13 contains in addition to the patient's photo 355′, the patient's contact information, pharmacy, allergies, additional helpful information, in this case that Mr. Wu should be provided liquid prescriptions if possible (because of a prior bariatric surgery as we shall see), and the patient's current medication list. Abbreviations well understood in the medical field are used to conform the data to a form readily useful on an abbreviated format, including a smart phone having an inherently limited display area. Unlike a desktop computer, a smart phone has a limited small screen size and limited convenience for inputting data from the touch screen key pad. All of the information presented in the program, and all inputs required, must conform to the limitations of the device display to be useful on HHD's.

After having reviewed the Personal Health Record, the physician may tap the “continue” button 322 to proceed. At this point, having selected a case and having considered the HPI and the PHR, and any optional files input by the patient, the physician develops a treatment plan and enters the library of alphabetically stored entries describing various treatment options. FIG. 14 illustrates a screen 360 labeled “Library” at 365, where treatment options are organized alphabetically. In this case the physician is searching for an option beginning with the letter “S.” By entering the search term in the bar 362, the physician locates the entry desired.

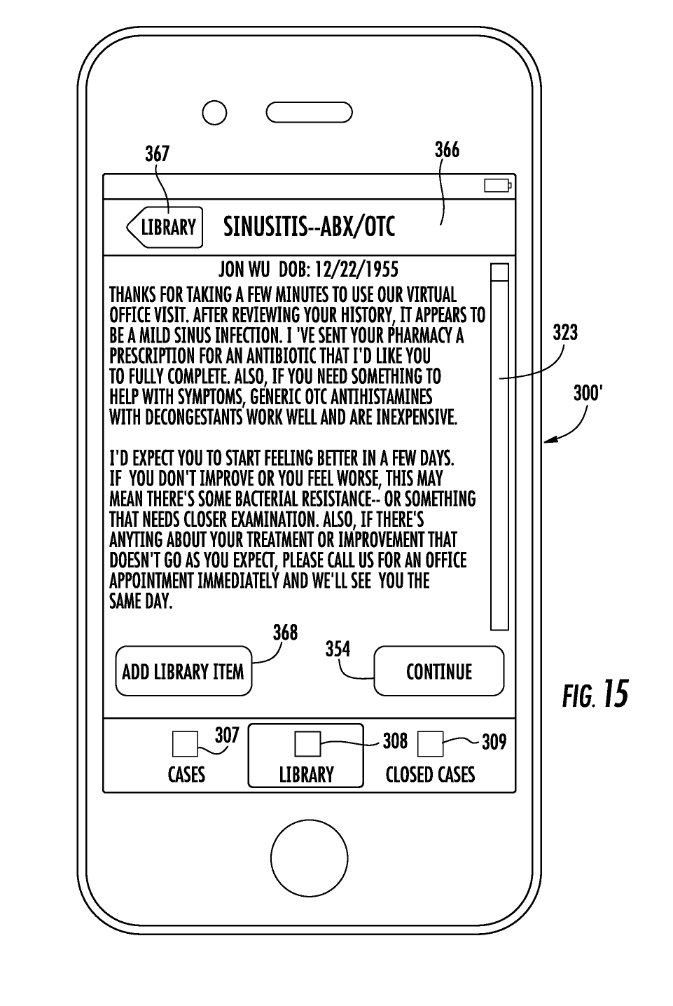

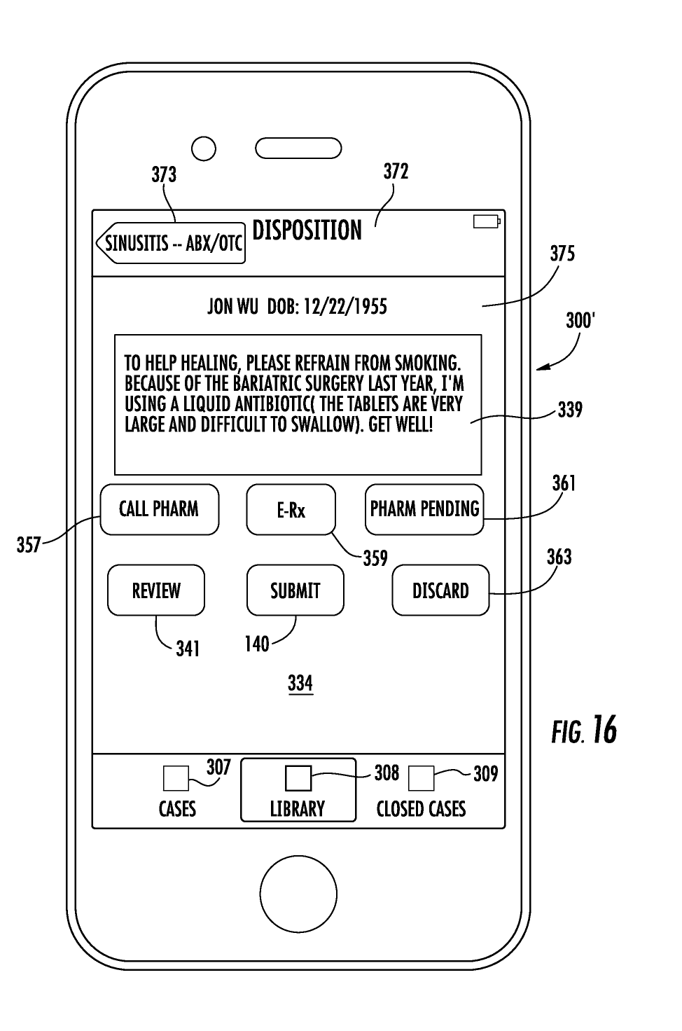

FIG. 15 illustrates the selection of the library entry 366 from FIG. 14 for the item “Sinusitis—ABX/OTC” for sinusitis to be treated with antibiotics and over-the-counter remedies to alleviate symptoms. The library item selected, 366, appears as a label in the upper central bar on the screen. The physician can enter more than one library item, if needed, by tapping the button 368 at “add library item.” The library item selected is entered for the patient with the patient's name and date of birth along with the description of the treatment plan. Having selected the treatment plan, the next screen loaded onto the physician's smart phone is the disposition screen 334 as illustrated in FIG. 16 and as discussed in FIGS. 3, 4A, and 5.

FIG. 16 illustrates the disposition screen 334, indicated by the label “disposition” in the upper bar 372. A button 373 containing the name of the treatment plan, which is the library item selected, enables the physician to return to the library screen for the item selected as shown on FIG. 15, potentially to select another item. The patient's name and date of birth head the screen at 375. The physician has chosen to add unstructured comments and has entered those comments at 339. From this screen the physician may select any of several functions, as discussed above in connection with FIG. 5. The physician may decide to contact the pharmacy and tap button 357 “call pharmacy” to initiate the call, or may decide to submit an electronic prescription via an “e-prescription” service, as at 359. The physician may also decide to review the screens and treatment plan by tapping the “review” button at 341 and following the flow chart described in connection with FIG. 6. Tapping buttons 357, 359, 341, and 339 allows the physician to take the action specified and to return to the disposition screen. Tapping buttons 361, 363, and 140 result in action that concludes the visit in a specified manner as previously discussed in connection with FIG. 5.

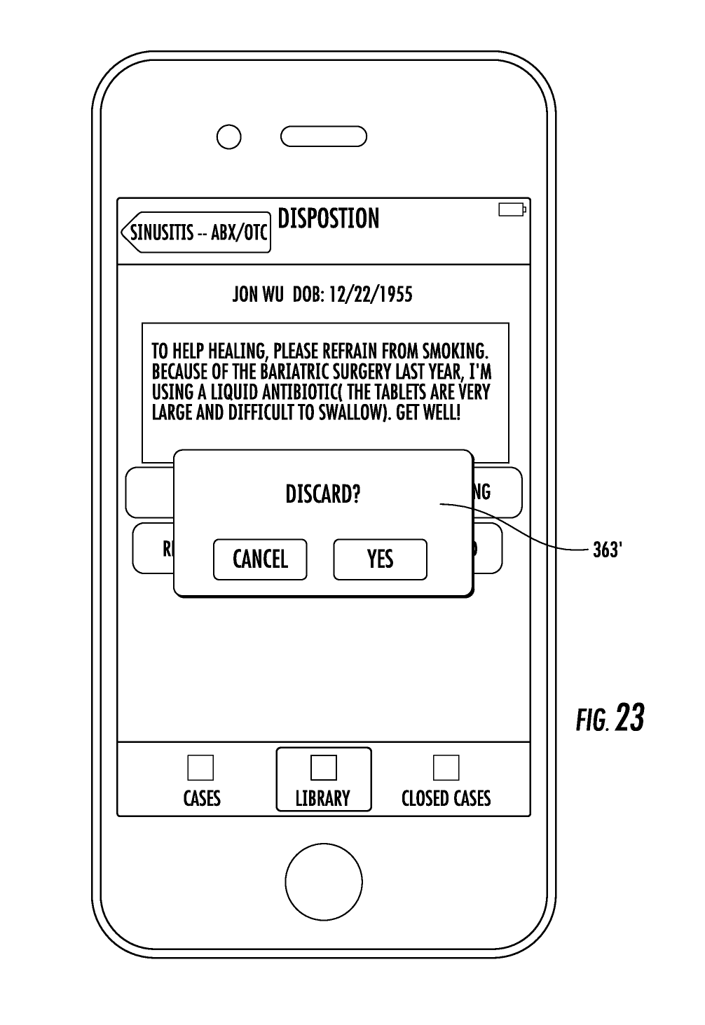

If the physician decides to mark the case as pending, step 360, FIG. 5, the physician taps the button 361, labeled “pharm pending” in FIG. 16, to highlight the patient's name on the case list, Jon Wu in this illustration, screen 305′, FIG. 19. This action preserves and stores the treatment plan, PHR, and HPI for later physician consideration and provides an indication to the physician upon next considering the cases list, screen 305′ that a treatment plan has been selected for the particular patient and the case is pending final disposition. By deciding to discard the treatment plan, including additional physician comments, step 362 and tapping the button 363 labeled “discard” in FIG. 16 and “remove treatment selection and comments” in FIG. 5, the physician removes the treatment plan that has been selected and the case is treated as new and remains unaltered on the cases list. This feature is further illustrated in FIG. 23, in which the physician has tapped “discard” button 363 and a confirmation window 363′ opens to confirm the action.

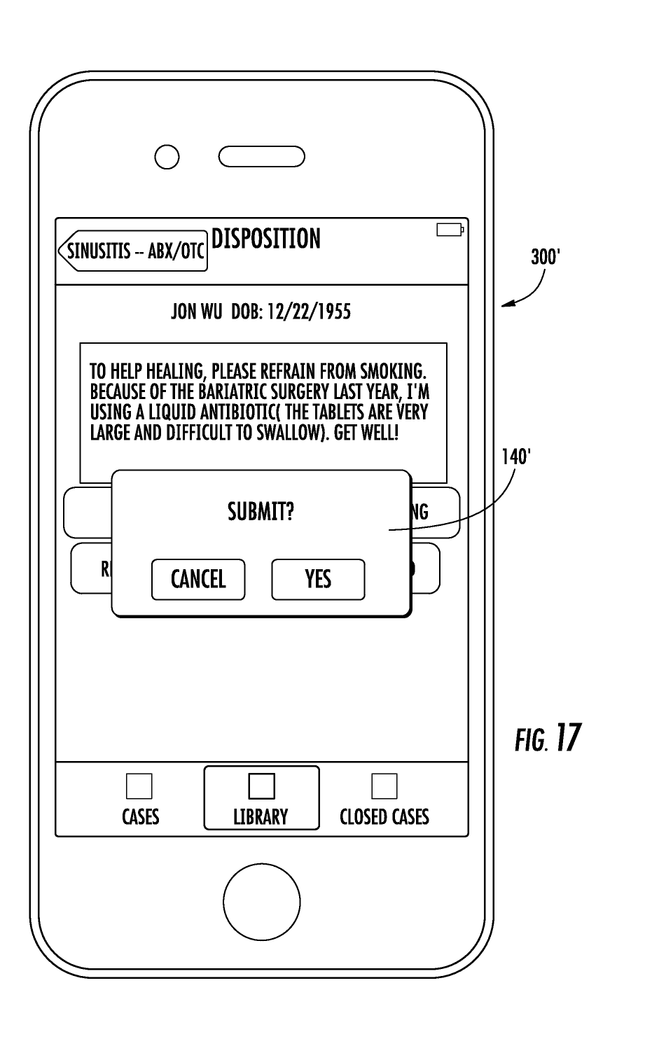

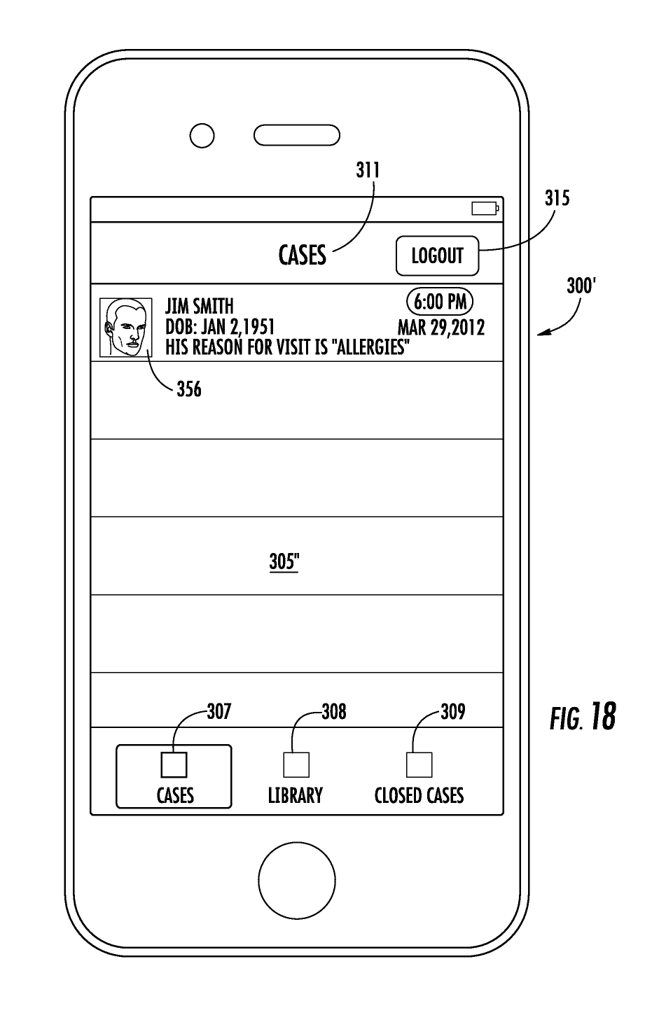

If the physician has selected a treatment plan and contacted the pharmacy as needed, then the treatment plan may be “submitted” by tapping button 140. Similar to tapping the “discard” icon 363, a confirmation window 140′ opens to confirm the action, FIG. 17, and initiates a server routine that notifies the patient, stores the visit on the central server 100 (FIG. 1) in file storage 175, forwards the completed visit to the physician's medical practice 200 for file storage 250, removes the patient's name from the list of pending cases, and closes the case (step 148, FIG. 5). The program returns the physician to the cases list as shown in FIG. 18, screen 305″, where the name of the patient for whom the medical visit is completed, Jon Wu in this illustration, has been removed (compare screen 305, FIG. 10).

FIGS. 20 through 22 illustrate screens 342, 346, and 350, respectively, of the “review” subroutine of FIG. 6, which are, respectively, the first screen of the HPI, the first screen of the PHR, and the first screen of the physician-selected treatment plan. In the ‘review” mode, buttons for each portion of the visit, which is the HPI, PHR, and treatment plan, are maintained at 355, 345, and 349, respectively. The physician may review selected portions of the visit immediately by tapping one of the three buttons and scrolling to the screen desired. Alternatively, the physician may press the “done” button 353 and return to the disposition screen 334, FIG. 16. The operation of the “review” mode is as described in respect of FIG. 6.

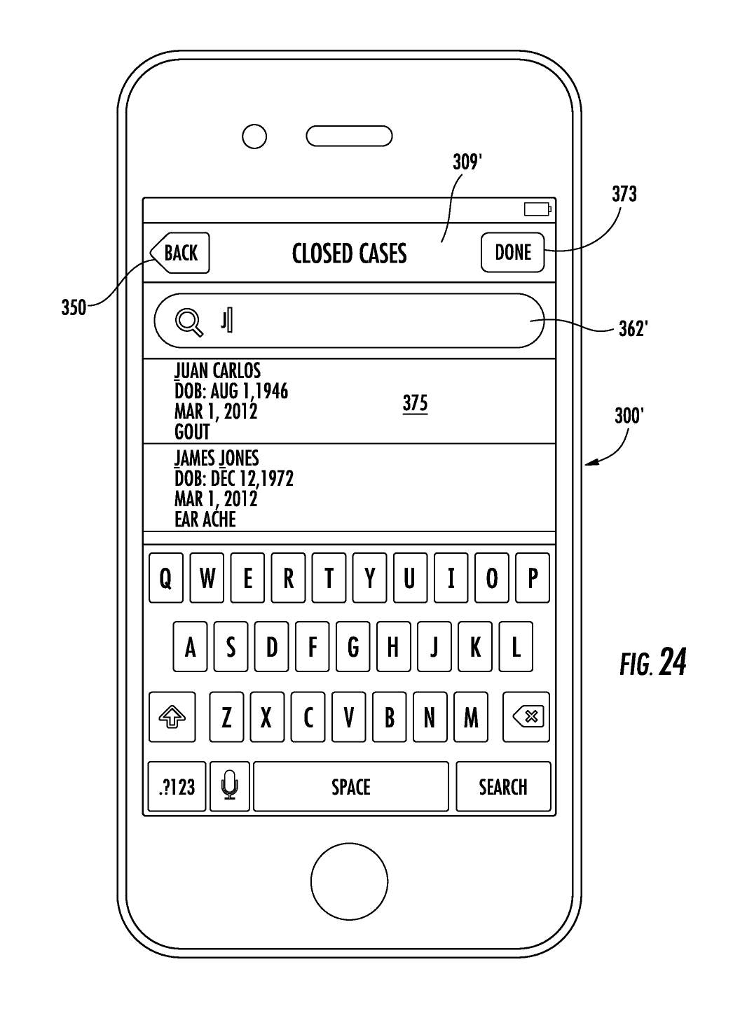

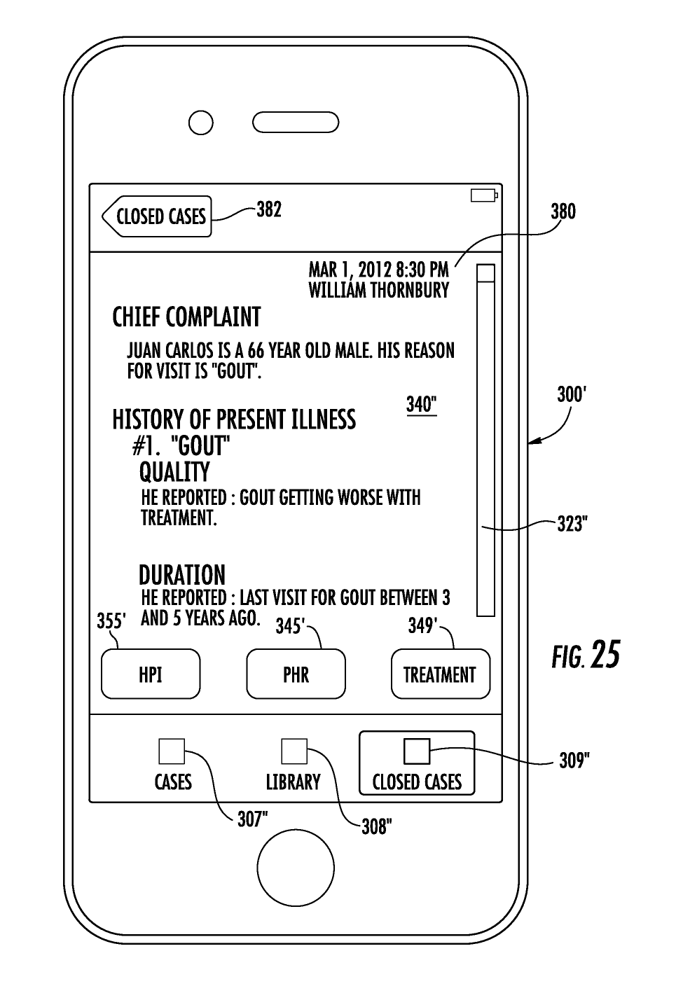

Turning now to the “closed cases” icon 309 of FIG. 10 et seq, FIGS. 24 through 27 illustrate the physician's tapping of this button to consider a previously completed and submitted medical visit for the patient Juan Carlos. The closed cases are those medical visits previously completed on the physician's HHD and stored in the central server 100 at storage file 175 (FIG. 1). The first screen opened on the physician's smart phone 300′ is a search screen 375 for closed cases. The physician enters the search criteria in search bar 362′ to locate the patient and upon selecting patient Juan Carlos opens the first screen of the History of Present Illness, FIG. 25, screen 340″, for Juan Carlos. Alternatively, the physician could tap the “back” button 350 to return to the active cases screen or the “done” button 373 to escape the closed cases and return to the active cases list screen 305, FIG. 10.

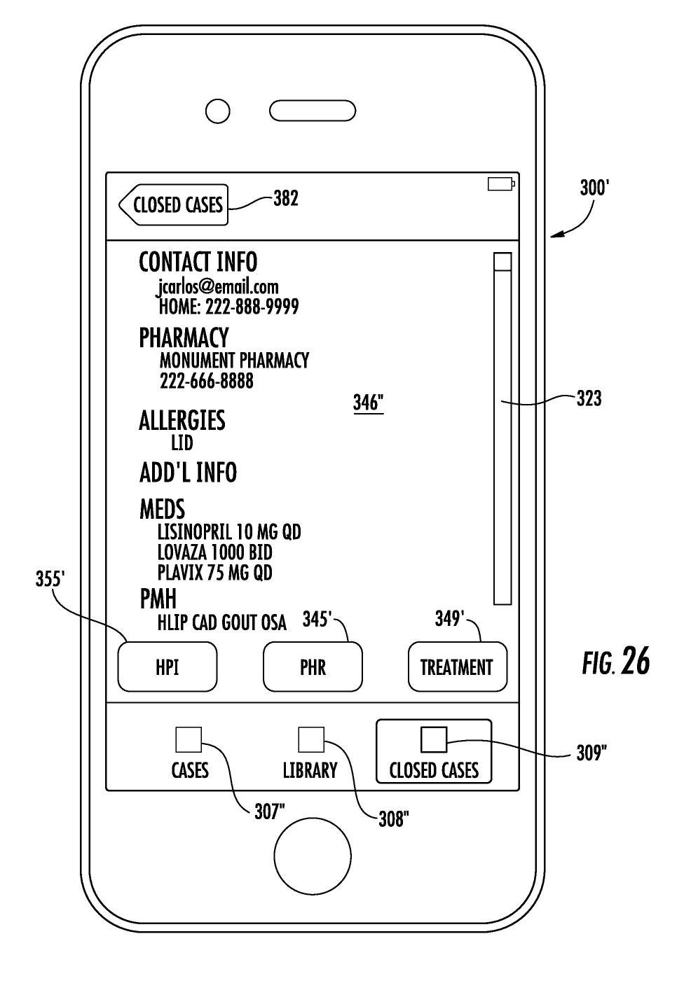

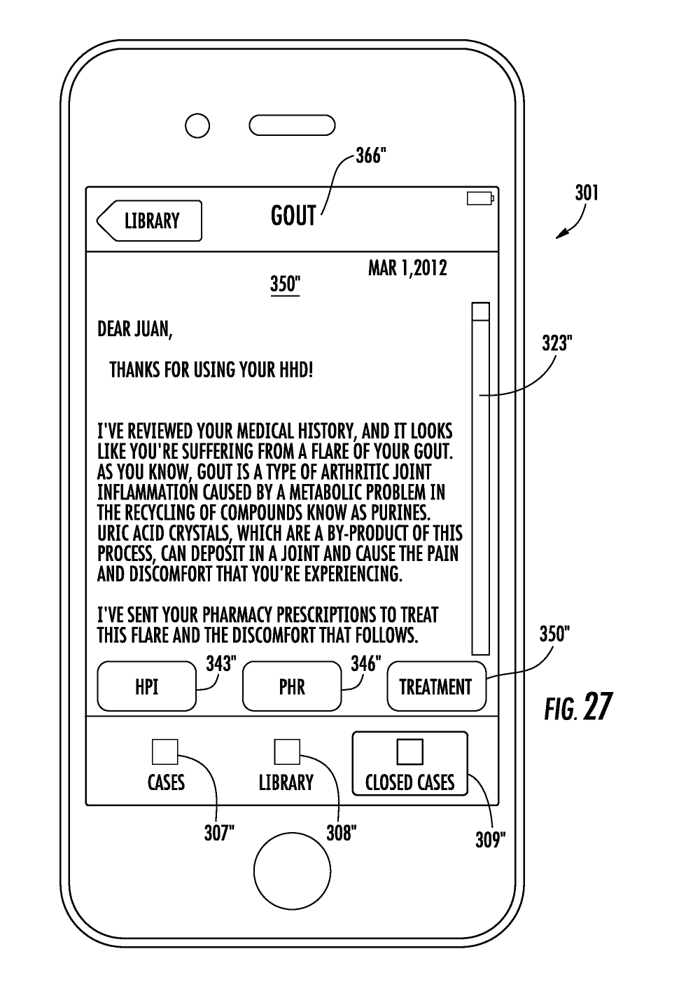

The HPI screen 340″ includes text 380 in the viewer's upper right that contains the name of the physician that the patient previously selected and who submitted the now closed case and the time at which the case was submitted and closed. From this screen the physician may review the HPI and scroll at 323″ through its screens, ultimately entering the Personal Health Record and then the treatment plan, or the physician may select one of the HPI, PHR, or treatment buttons 355′, 345′, or 349′, respectively, to enter one of these portions of a closed case immediately, landing on the first screen of the selected section. The physician may also tap the closed cases button 382 on the upper left of the screen to return to the closed cases search screen at 362′. FIG. 26 illustrates the first PHR screen 346″ and FIG. 27 illustrates the first treatment screen 350″. It should be recognized that the “closed cases” button 309 is highlighted when the physician is located in this section of the application and that the physician can return to the active cases list at screen 305 simply by tapping button 307″ or the first library screen by tapping button 308″.

By combining the ability to use medical records files, including a current presenting complaint and the patient's health record (store-forward documents) with real-time audio and video access through mobile technology, formatted for minimum data input so that the system can be used in connection with devices having limited display area, the invention permits the Medical Home to be expanded beyond its present boundaries to include the primary care physician. A library of pre-refined responses to specific disease states for a variety of stable chronic and minor medical conditions enable efficiencies in the delivery of medical services heretofore unavailable. The invention providing these capabilities is defined as set forth in the appended claims and all equivalents thereto, including changes in form and detail that do not depart from the true scope of the invention.

What is claimed is:

1. A system for providing medical services adapted for use with hand held wireless devices comprising:
a. a health care practitioner's communications device and a patient's communications device;
b. a medical interrogation engine for collecting input from a hand held wireless device and structuring a presenting complaint; and
c. a central interface server having file storage media including the patient's health record and a treatment library of medical responses to presenting complaints wherein the responses are adapted for selection and presentation on hand held wireless devices, the server in communication with each of the patient's device, the practitioner's device, and the medical interrogation engine and establishing communication between the patient's device and the medical interrogation engine, the server communicating the presenting complaint from the medical interrogation engine to the practitioner's device, whereby the practitioner may consider the presenting complaint and the patient's health record and select at least one response from the treatment library, and whereby the server stores the at least one selected response on the file storage media and communicates the at least one selected response to the patient's device, thereby providing medical services from the practitioner to the patient.

2. The system of claim 1 wherein at least one of the practitioner's and patient's communications devices is a hand held wireless device.

3. The system of claim 1 wherein at least one of the practitioner's and patient's communications devices is a smart phone.

4. The system of claim 1 wherein at least one of the practitioner's and patient's communications devices is a tablet.

5. The system of claim 1 wherein each of the practitioner's and patient's communications devices is a hand held wireless device.

6. The system of claim 1 wherein the medical interrogation engine further comprises collecting input that remains unstructured.

7. The system of claim 1 wherein the medical interrogation engine further comprises collecting input that remains unstructured and in the patient's own words.

8. The system of claim 1 wherein the medical interrogation engine further comprises collecting at least one of audio or image input that remains unstructured.

9. The system of claim 1 wherein the medical interrogation engine further comprises collecting up to five each of audio or image input files that remain unstructured.

10. The system of claim 1 wherein the practitioner may add unstructured comment to the at least one selected response to the patient, the server storing and communicating to the patient's device the unstructured comment in addition to the selected response.

11. The system of claim 1 further comprising a financial transactions engine in communication with the central interface server, the server establishing communication between the financial transactions engine and the patient's communications device, whereby the financial transactions engine collects payment from the patient's communications device and confirms payment to the server and thereafter the medical interrogation engine collects input from the patient's communications device, structures the presenting complaint, and communicates the presenting complaint to the server for storage and communication to the practitioner's device.

12. The system of claim 1 further comprising the practitioner's medical practice, the medical practice having file storage media for medical services provided through the system, the medical practice communicating with the central interface server for receiving completed records of medical services including the presenting complaint, the patient's health record, and the medical response selected by the practitioner.

13. The system of claim 1 further comprising external references in communication with the practitioner's communications device, whereby the practitioner may consult the references in connection with considering the patient's personal health record and selecting at least one medical response from the treatment library.

14. The system of claim 1 further comprising the patient's pharmacy in communication with practitioner's communications device, whereby the practitioner may contact the pharmacy to prescribe medications for the patient in connection with selecting at least one medical response from the treatment library.

15. The system of claim 1 further comprising an electronic prescribing engine in communication with practitioner's communications device and the patient's pharmacy, whereby the practitioner may e-prescribe medications for the patient.

16. The system of claim 1 wherein the practitioner's considering the presenting complaint and patient's health record, selecting at least one response from the treatment library, storing the presenting complaint, health record and selected response, and communicating the at least one response to the patient's hand held device takes place in from about 1 to 3 minutes.

17. A system for providing medical services adapted for use with hand held wireless devices comprising:
a. a health care practitioner's hand held wireless device and a patient's hand held wireless device;
b. a medical interrogation engine for collecting input from the patient's device, structuring a presenting complaint, optionally presenting input in the patient's own words, and optionally providing up to five audio and five image files;
c. a financial transactions engine for collecting payment from the patient's communications device;
d. a medical practice with which the practitioner is associated, the medical practice having file storage media for medical services provided through the system;
e. external references in communication with the practitioner's device:
f. a pharmacy from which the patient obtains prescriptions, the pharmacy in communication with practitioner's device, whereby the practitioner may contact the pharmacy to prescribe medications for the patient, or an electronic prescribing engine in communication with the practitioner's device and the patient's pharmacy, whereby the practitioner may e-prescribe medications for the patient; and
g. a central interface server having file storage media including the patient's health record and a treatment library of medical responses to presenting complaints wherein the responses are adapted for selection and presentation on hand held wireless devices, the server in communication with each of the patient's device, the practitioner's device, the medical interrogation engine, and the financial transactions engine and establishing communication between the patient's device and the medical interrogation engine and the financial transactions engine, the server verifying payment from the financial transactions engine and communicating the presenting complaint from the medical interrogation engine to the practitioner's device, whereby the practitioner may consider the presenting complaint and the patient's health record, optionally consult external references, select at least one response from the treatment library, and optionally prescribe medications either by contacting the patient's pharmacy or e-prescribing, and whereby the server stores the presenting complaint, at least one selected response and optional prescriptions on the file storage media and communicates the at least one selected response and optional prescriptions to the patient's device and communicates to the practitioner's medical practice for storage on the medical practice file storage media the presenting complaint, the patient's personal health record, the treatment response, and optional prescriptions, thereby providing and documenting medical services from the practitioner to the patient.

18. The system of claim 17 wherein the central interface server includes in the application for the practitioner's hand held device and after selection of a medical response from the treatment library, optionally collecting unstructured input from the practitioner for including with the selected treatment response and communicating the unstructured input to the patient's hand held device.

19. The system of claim 17 wherein the central interface server includes in the application for the practitioner's hand held device and after selection of a medical response from the treatment library optionally marking the patient's presenting complaint and medical response as pending, optionally discarding the medical response, reviewing one or more of the presenting complaint, the patient's personal health record, and the one or more medical responses selected, and contacting the patient for an audio or visual conference, and thereafter submitting the medical response to the server for storage and communication to the patient's hand held device.

20. The system of claim 17 wherein the central interface server includes in the application for the patient's hand held device and prior to establishing communication between the financial transactions engine and the patient's device, collecting input from the patient's device for selecting a physician, establishing medical consent, acknowledging disclaimers, and verifying account information.

21. A method for a medical practitioner to select and approve a treatment library of medical responses for use in connection with hand held devices, the method comprising the steps of:
a. accessing the practitioner's personal library of prepared treatment medical responses on a central interface server;
b. selecting a prepared treatment medical response or creating a new response;
c. optionally amending the response;
d. accepting the response; and
e. optionally selecting a different prepared response or creating a different new response and repeating steps (a) through (e) as needed to select and approve a treatment library.

22. A method for providing medical services through hand held wireless devices from a medical practitioner to a patient, the method comprising the steps of:
a. providing patient access through a hand held wireless device to a central interface server, the patient:
i. reviewing the patient's personal health record (“PHR”);
ii. optionally updating the PHR;
iii. selecting a practitioner;
iv. completing consent forms, acknowledging disclaimers, and verifying account information;
v. making payment;
vi. completing a history of present illness (“presenting complaint”); and
vii. optionally adding image or audio files;
b. notifying the practitioner from the central interface server and through the practitioner's hand held wireless device that the patient has submitted a presenting complaint;
c. providing practitioner access through the practitioner's hand held device and the central interface server to the patient's presenting complaint and PHR, the practitioner:
i. considering the presenting complaint and optional image or audio files;
ii. considering the PHR;
iii. optionally considering external resources and optionally contacting the patient by audio or video conference;
iv. selecting a prepared treatment plan from a treatment library of medical responses on the central interface server;
v. optionally including additional comments and prescribing medications; and
vi. submitting the treatment plan to the central interface server;
d. storing the presenting complaint, PHR, treatment plan, and optional additional comments on the central interface server; and
e. notifying the patient of the treatment plan and optional additional comments.

23. The method of claim 22 further comprising the step of storing the presenting complaint, PHR, treatment plan, and optional additional comments on the practitioner's medical practice server.

24. The method of claim 22 further comprising the step of the practitioner considering a presenting complaint, PHR, treatment plan, and optional additional comments previously stored on the central interface server.

25. The method of claim 22 further comprising the step of the practitioner selecting the patient from a list of patients presented on the practitioner's hand held device prior to considering the patient's presenting complaint.

26. The method of claim 22 further comprising the steps of optionally reviewing at least one of the presenting complaint, optionally added image and audio files, the PHR, the treatment plan, and optionally added additional comments and optional prescriptions; marking the treatment plan as pending; and discarding the treatment plan.

27. The method of claim 22 wherein step (c) takes place in from about 1 to 3 minutes.

28. A system for providing medical services electronically between a provider and a remote patient, the system comprising store-and-forward functions for a presenting complaint, a health record, and treatment options in combination with real-time communications between the provider and remote patient.
